(19) United States
(12) Patent Application Publication
(10) Pub. No.: US 2026/0365065 A1
(43) Pub. Date: Nov. 19, 2026

(54) ADAPTIVE BI-DIRECTIONAL CHARGING CONTROL

(71) Applicant: Volvo Car Corporation, Gothenburg (SE)

(72) Inventor: Aditya Pratap Singh, Gothenburg (SE)

(73) Assignee: Volvo Car Corporation, Gothenburg (SE)

(21) Appl. No.: 19/206,181

(22) Filed: May 13, 2025

(51) Int. Cl. B60L 53/63; B60L 53/66; B60L 53/68; B60L 55/00

(52) U.S. Cl. CPC B60L 53/63; B60L 53/66; B60L 53/68; B60L 55/00

(57) ABSTRACT

A system is described. The system comprises: one or more sensors, a control unit, a memory, and a processor, communicatively coupled to the one or more sensors and storing instructions in non-transitory memory that, when executed, causes the processor to measure a grid power profile of a grid using the one or more sensors; compare the measured grid power profile with a reference grid power profile; determine a deviation between the measured grid power profile and the reference grid power profile; determine a vehicle discharge power profile during discharging of a battery pack of a vehicle; communicate a command to the control unit to modify the vehicle discharge power profile based on the deviation between the measured grid power profile and the reference grid power profile; and receive the modified vehicle discharge power profile from the control unit and transmit the modified vehicle discharge power profile to the grid.

### TECHNICAL FIELD

The present disclosure relates generally to energy management in bi-directional electric vehicle charging systems, including Vehicle-to-Grid (V2G) and Grid-to-Vehicle (G2V) operations. More specifically, the present disclosure relates to a system and method for dynamically modifying both vehicle discharge profiles during V2G operation and grid power profiles during G2V operation to enhance grid stability and improve overall power quality.

### BACKGROUND

With the rapid adoption of Electric Vehicles (EVs), bi-directional charging technologies encompassing both Vehicle-to-Grid (V2G) and Grid-to-Vehicle (G2V) operations have become essential components of modern power management systems. V2G enables EVs to discharge power back to the grid to help stabilize fluctuations in energy demand, while G2V facilitates controlled charging of EVs based on grid availability. Despite their potential, current V2G and G2V systems face critical challenges in dynamically managing bidirectional energy flow. During V2G operation, simultaneous discharging by multiple EVs especially during incentive periods can lead to grid overloading, voltage instability, and frequency deviations. Similarly, in G2V scenarios, uncontrolled charging during off-peak hours may contribute to grid congestion and power quality degradation.

Therefore, there is a long-felt need for a system and method to adaptively modify both vehicle discharge and grid charging power profiles based on real-time grid conditions, thereby enhancing grid stability and energy efficiency.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

In one or more embodiments described herein, systems, devices, computer-implemented methods, methods, apparatus and/or computer program products are presented that facilitate modifying a vehicle discharge profile during the vehicle-to-grid (V2G) operation.

In an aspect, a system is described. The system comprises: one or more sensors, a control unit, a memory, and a processor, communicatively coupled to the one or more sensors and storing instructions in non-transitory memory that, when executed, causes the processor to measure a grid power profile of a grid using the one or more sensors; compare the measured grid power profile with a reference grid power profile; determine a deviation between the measured grid power profile and the reference grid power profile; determine a vehicle discharge power profile during discharging of a battery pack of a vehicle; communicate a command to the control unit to modify the vehicle discharge power profile based on the deviation between the measured grid power profile and the reference grid power profile; and receive the modified vehicle discharge power profile from the control unit and transmit the modified vehicle discharge power profile to the grid.

In one aspect, a method is described. The method comprises: measuring a grid power profile of a grid using one or more sensors; comparing the measured grid power profile with a reference grid power profile; determining a deviation between the measured grid power profile and the reference grid power profile; determining a vehicle discharge power profile during discharging of a battery pack of a vehicle; communicating a command to a control unit to modify the vehicle discharge power profile based on the deviation between the measured grid power profile and the reference grid power profile; and receiving the modified vehicle discharge power profile from the control unit and transmitting the modified vehicle discharge power profile to the grid.

In one aspect, a non-transitory computer readable storage medium is described. The non-transitory computer readable storage medium comprising a sequence of instructions, which when executed by a processor causes: measuring a grid power profile of a grid using one or more sensors; comparing the measured grid power profile with a reference grid power profile; determining a deviation between the measured grid power profile and the reference grid power profile; determining a vehicle discharge power profile during discharging of a battery pack of a vehicle; communicating a command to a control unit to modify the vehicle discharge power profile based on the deviation between the measured grid power profile and the reference grid power profile; and receiving the modified vehicle discharge power profile from the control unit and transmitting the modified vehicle discharge power profile to the grid.

The methods and systems disclosed herein may be implemented in any means for achieving various aspects and may be executed in a form of a non-transitory machine-readable medium embodying a set of instructions that, when executed by a machine, causes the machine to perform any of the operations disclosed herein. Other features will be apparent from the accompanying drawings and from the detailed description that follows.

### BRIEF DESCRIPTION OF THE FIGURES

These and other aspects of the present disclosure will now be described in more detail, with reference to the appended drawings showing exemplary embodiments, in which:

FIG. 1 illustrates a system for modifying a vehicle discharge power profile according to one or more embodiments.

FIG. 2 illustrates a method for modifying a vehicle discharge power profile according to one or more embodiments.

FIG. 3 illustrates a non-transitory computer readable storage medium block diagram for modifying a vehicle discharge power profile, according to one or more embodiments.

FIG. 4 illustrates a block diagram of a system that modifies a vehicle discharge power profile according to one or more embodiments.

FIG. 5 illustrates a battery pack comprising an individual battery, according to one or more embodiments.

FIG. 6 illustrates a battery pack comprising a plurality of batteries, according to one or more embodiments.

FIG. 7 schematically shows a battery pack comprising a battery and a battery management system, according to one or more embodiments.

FIG. 8 illustrates an example command communicated from the system to modify a vehicle discharge power profile based on deviations between the measured grid power profile and the reference grid power profile, according to one or more embodiments.

FIGS. 9A-9D illustrate a voltage profile and a current profile corresponding to Vehicle-to-Grid (V2G) operation, according to one or more embodiments.

FIG. 10 illustrates a system for modifying a grid power profile, according to one or more embodiments.

FIG. 11 illustrates a method for modifying a grid power profile according to one or more embodiments.

FIG. 12 illustrates a non-transitory computer readable storage medium for modifying a grid power profile, according to one or more embodiments.

FIG. 13 illustrates a block diagram of a system that modifies a grid power profile according to one or more embodiments.

FIG. 14 illustrates an example command communicated to the control unit to modify the grid power profile based on the deviation between the measured grid power profile and the reference grid power profile according to one or more embodiments.

FIG. 15 illustrates a system in which one or more vehicles form a microgrid for bi-directional energy transfer, supporting both vehicle-to-grid (V2G) and grid-to-vehicle (G2V) operations, according to one or more embodiments.

FIG. 16 illustrates a block diagram that transmits a modified vehicle discharge power profile according to one or more embodiments.

FIG. 17 illustrates a block diagram of an Artificial Intelligence (AI) model according to one or more embodiments.

FIG. 18A shows a structure of the neural network/machine learning model with a feedback loop.

FIG. 18B shows a structure of the neural network/machine learning model with reinforcement learning.

FIG. 19A shows a block diagram of the cyber security module in view of the system and server.

FIG. 19B shows an embodiment of the cyber security module.

FIG. 19C shows another embodiment of the cyber security module.

Other features of the present embodiments will be apparent from the accompanying drawings and from the detailed description that follows.

### DETAILED DESCRIPTION

For simplicity and clarity of illustration, the figures illustrate the general manner of construction. The description and figures may omit the descriptions and details of well-known features and techniques to avoid unnecessarily obscuring the present disclosure. The figures exaggerate the dimensions of some of the elements relative to other elements to help improve understanding of embodiments of the present disclosure. The same reference numeral in different figures denotes the same element.

Although the detailed description herein contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs.

Unless defined otherwise, all technical and scientific terms used herein have the same meaning as commonly understood by one with ordinary skill in the art.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left,” “right,” “front,” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Furthermore, the term “set” includes items (e.g., related items, unrelated items, a combination of related items and unrelated items, etc.) and may be interchangeable with “one or more”. Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the terms “couple,” “coupled,” “couples,” “coupling,” and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably,” “removable,” and the like, near the word “coupled” and the like does not mean that the coupling, etc., in question is or is not removable.

As used herein, the term “or” means an inclusive “or” rather than an exclusive “or.” That is, unless specified otherwise, or clear from context. “X employs A or B” means any of the natural inclusive permutations. That is, if X employs A; X employs B; or X employs both A and B, then “X employs A or B” is satisfied under any of the foregoing instances.

As used herein, two or more elements or modules are “integral” or “integrated” if they operate functionally together. Two or more elements are “non-integral” if each element can operate functionally independently.

As used herein, the term “real-time” refers to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Digital electronic circuitry, or in computer software, firmware, or hardware, including the structures disclosed in this specification and their structural equivalents, or in combinations of one or more of them may realize the implementations and all of the functional operations described in this specification. Implementations may be as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a stand-alone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of a digital computer. A processor will receive instructions and data from a read-only memory or a random access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc., may embed a computer. Computer readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disk Read-Only Memory (CD-ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship with each other.

Embodiments may comprise or utilize a special purpose or general purpose computer including computer hardware. Embodiments within the scope of the present disclosure may also include physical and other computer readable media for carrying or storing computer-executable instructions and/or data structures. Such computer readable media can be any media accessible by a general purpose or special purpose computer system. Computer readable media that store computer-executable instructions are physical storage media. Computer readable media that carry computer-executable instructions are transmission media. Thus, by way of example and not limitation, embodiments of the disclosure can comprise at least two distinct kinds of computer readable media: physical computer readable storage media and transmission computer readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer readable storage media includes RAM, ROM, EEPROM, CD-ROM or other optical disk storage (such as CDs, DVDs, etc.), magnetic disk storage or other magnetic storage devices, solid-state disks or any other medium. They store the desired program code in the form of computer-executable instructions or data structures which can be accessed by a general purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer readable media includes combinations of the above, that enable the transport of electronic data between computer systems and/or modules and/or other electronic devices. Further, upon reaching various computer system components, program code in the form of computer-executable instructions or data structures can be transferred automatically from transmission computer readable media to physical computer readable storage media (or vice versa). For example, computer-executable instructions or data structures received over a network or data link can be buffered in RAM within a Network Interface Controller (NIC), and then eventually transferred to computer system RAM and/or to less volatile computer readable physical storage media at a computer system. Thus, computer system components that also (or even primarily) utilize transmission media may include computer readable physical storage media.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer readable media such as computer memory may practice the methods. In particular, one or more processors execute computer-executable instructions, stored in the computer memory, to perform various functions such as the acts recited in the embodiments.

Those skilled in the art will appreciate that the disclosure may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAS, pagers, routers, switches, etc. Distributed system environments where local and remote computer systems, which are linked (either by hardwired data links, wireless data links, or by a combination of hardwired and wireless data links) through a network, both perform tasks may also practice the disclosure. In a distributed system environment, program modules may be located in both local and remote memory storage devices.

The following terms and phrases, unless otherwise indicated, shall have the following meanings.

As used herein, the term “vehicle” as used herein refers to a thing used for transporting people or goods. Automobiles, cars, trucks, buses, etc., are examples of vehicles.

As used herein, the term “electric vehicle (EV)” refers to an automobile, as defined in 49 Code of Federal Regulations (CFR) 523.3, intended for highway use, powered by an electric motor that draws current from an on-vehicle energy storage device, such as a battery, which is rechargeable from an off-vehicle source, such as residential or public electric service or an on-vehicle fuel powered generator. The EV may be two or more wheeled vehicles manufactured for use primarily on public streets and roads. The EV may be referred to as an electric car, an electric automobile, an electric road vehicle (ERV), a plug-in vehicle (PV), a plug-in vehicle (xEV), etc., and the xEV may be classified into a plug-in all-electric vehicle (BEV), a battery electric vehicle, a plug-in electric vehicle (PEV), a hybrid electric vehicle (HEV), a hybrid plug-in electric vehicle (HPEV), a plug-in hybrid electric vehicle (PHEV), etc.

As used herein, the term “plug-in electric vehicle (PEV)” refers to an Electric Vehicle that recharges the on-vehicle primary battery by connecting to the power grid.

As used herein, the term “plug-in vehicle (PV)” refers to an electric vehicle rechargeable through wireless charging from an electric vehicle supply equipment (EVSE) without using a physical plug or a physical socket.

As used herein, the term “heavy duty vehicle (HD Vehicle)” refers to any four-or-more wheeled vehicle as defined in 49 CFR 523.6 or 49 CFR 37.3 (bus).

As used herein, the term “light duty plug-in electric vehicle” refers to a three or four-wheeled vehicle propelled by an electric motor drawing current from a rechargeable storage battery or other energy devices for use primarily on public streets, roads and highways and rated at less than 4,545 kg, (10,000 lbs.) gross vehicle weight.

As used herein, the term “battery pack” as used herein refers to a set of any number of identical batteries or individual cells of a battery. The “battery pack” may also refer to a set of non-identical batteries. The batteries in the battery pack may be configured in series, parallel or a mixture of both to deliver the desired voltage, capacity, and/or power density.

As used herein, the term “grid power profile” refers to a set of electrical parameters that represent the real-time operating conditions of the power grid. The grid power profile comprises a voltage profile, a current profile, a frequency profile, and a power quality profile.

As used herein, the term “reference grid power profile” refers to a predefined set of electrical parameters that represent the ideal operating conditions of the power grid. The reference grid power profile comprises a voltage profile, a current profile, a frequency profile, and a power quality profile.

As used herein, the term “voltage profile” refers to the measurement and representation of voltage levels across the grid or the vehicle power system over a period of time. It reflects voltage fluctuations, stability, and deviations from the reference voltage.

As used herein, the term “current profile” refers to the measurement of electric current flow within the grid or the vehicle power system.

As used herein, the term “frequency profile” refers to the measurement and variation of the electrical grid's frequency over time, which reflects the balance between power generation and consumption within the grid system.

As used herein, the term “power quality profile” refers to the set of electrical parameters that determine the stability, reliability, and efficiency of power distribution in a grid or an electric vehicle power system. The power quality profile comprises harmonics, voltage fluctuations, phase imbalance, power factor, and total harmonic distortion (THD).

As used herein, the term “harmonics” refers to distortions in the electrical waveform within the grid, caused by non-linear loads such as power electronics, industrial machinery, and renewable energy inverters.

As used herein, the term “voltage fluctuations” refers to variations in grid voltage levels due to sudden changes in load demand, switching operations, or unstable power generation sources.

As used herein, the term “phase imbalance” refers to an unequal voltage or current distribution across the three phases of the grid.

As used herein, the term “power factor” refers to the ratio of real power (usable power) to apparent power (total power supplied) within the grid.

As used herein, the term “total harmonic distortion (THD)” refers to a measure of waveform distortion within the grid due to the presence of harmonics.

As used herein, the term “State of Charge (SoC)” refers to the current energy level of a battery expressed as a percentage of its total capacity. It indicates how much energy remains available for use or discharge.

As used herein, the term “State of Health (SoH)” refers to a measure of a battery's condition relative to its original capacity and performance when new. SoH is expressed as a percentage and accounts for factors such as capacity fade, internal resistance, and degradation over time.

As used herein, the term “charging capacity” refers to the maximum amount of electrical power that a vehicle's battery pack can receive from a charging source within a given time period.

As used herein, the term “discharge capacity” refers to the maximum amount of electrical energy that a vehicle's battery pack can deliver during a discharge cycle.

As used herein, the term “command” refers to a control signal or instruction generated by the processor to modify the grid power profile based on real-time deviations between the measured grid power profile and the reference grid power profile. The command may be communicated over a wired or wireless network and can be generated autonomously based on predefined grid conditions or dynamically based on real-time grid analysis.

As used herein, the term “seasonal demand patterns” refers to the variations in electricity consumption and grid load that occur due to changes in seasons, climate conditions, and energy usage trends.

As used herein, the term “weather conditions” refers to the real-time atmospheric parameters that impact electricity consumption, grid stability, and renewable energy generation. Weather conditions may include temperature, humidity, wind speed, cloud cover, precipitation, and extreme weather events.

As used herein, the term “ideal grid power profile” refers to a set of predefined electrical parameters representing the optimal operating conditions of the grid under normal load conditions. The ideal grid power profile comprises an ideal voltage profile, an ideal current profile, an ideal frequency profile, and an ideal power quality profile.

As used herein, the term “vehicle discharge power profile” refers to a set of electrical parameters that define the power output characteristics of an electric vehicle (EV) battery during the discharge process. The vehicle discharge power profile comprises a discharging voltage profile, a discharging current profile, a discharging frequency profile, and a discharging power quality profile.

As used herein, the term “discharging voltage profile” refers to the variation in voltage levels supplied by the vehicle's battery pack during discharge operations.

As used herein, the term “discharging current profile” refers to the real-time flow of electrical current from the vehicle's battery pack during discharging.

As used herein, the term “discharging frequency profile” refers to the frequency of the electrical power supplied by the vehicle during discharge, measured in Hertz (Hz).

As used herein, the term “discharging power quality profile” refers to the assessment of power stability and efficiency during vehicle discharge operations.

As used herein, the term “vehicle computer system” refers to a system in automotive electronics that controls one or more of the electrical systems or subsystems in a vehicle. The computer executes a large number of different software functions in the powertrain, chassis, driver assistance, and infotainment domains, etc., that are executed on separate control units. The vehicle computer system may be communicatively coupled with an external device of a user.

As used herein, the term “interactive display” refers to a user interface embedded in or mounted on a wall-mounted unit that allows users to interact with and control various functions or settings related to a system.

As used herein, the term “user device” refers to any electronic or digital equipment used by an individual to interact with or control a system. The user device can be a smartphone, tablet, laptop or desktop computer and smartwatch.

As used herein, the term “communication” refers to the transmission of information and/or data from one point to another. Communication may be by means of electromagnetic waves. It is also a flow of information from one point, known as the source, to another, the receiver. Communication comprises one of the following: transmitting data, instructions, and information or a combination of data, instructions, and information. Communication happens between any two communication systems or communicating units. The term “in communication with” may refer to any coupling, connection, or interaction using electrical signals to exchange information or data, using any system, hardware, software, protocol, or format, regardless of whether the exchange occurs wirelessly or over a wired connection. The term “communication” includes systems that combine other more specific types of communication, such as V2I (Vehicle-to-Infrastructure), V2I (Vehicle-to-Infrastructure), V2N (Vehicle-to-Network), V2V (Vehicle-to-Vehicle), V2P (Vehicle-to-Pedestrian), V2D (Vehicle-to-Device) and V2G (Vehicle-to-Grid) and Vehicle-to-Everything (V2X) communication. V2X communication is the transmission of information from a vehicle to any entity that may affect the vehicle, and vice versa. The main motivations for developing V2X are occupant safety, road safety, traffic efficiency and energy efficiency. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.). Further, the emergency communication apparatus is configured on a computer with the communication function and is connected for bi-directional communication with the on-vehicle emergency report apparatus by a communication line through a radio station and a communication network such as a public telephone network or by satellite communication through a communication satellite. The emergency communication apparatus is adapted to communicate, through the communication network, with communication terminals including a road management office, a police station, a fire department, and a hospital. The emergency communication apparatus can also be connected online with the communication terminals of the persons or vehicles concerned, associated with the occupant or vehicle, and the driver or vehicle receiving the service of the emergency-reporting vehicle.

The terms “non-transitory computer readable medium” and “computer readable medium” include a single medium or multiple media such as a centralized or distributed database, and/or associated caches and servers that store one or more sets of instructions. Further, the terms “non-transitory computer readable medium” and “computer readable medium” include any tangible medium that is capable of storing, encoding, or carrying a set of instructions for execution by a processor that, for example, when executed, cause a system to perform any one or more of the methods or operations disclosed herein. As used herein, the term “computer readable medium” is expressly defined to include any type of computer readable storage device and/or storage disk and to exclude propagating signals.

The term, “handshaking” refers to an exchange of predetermined signals between agents connected by a communications channel to assure each that it is connected to the other (and not to an imposter). This may also include the use of passwords and codes by an operator. Handshaking signals are transmitted back and forth over a communications network to establish a valid connection between two stations. A hardware handshake uses dedicated wires such as the request-to-send (RTS) and clear-to-send (CTS) lines in an RS-232 serial transmission. A software handshake sends codes such as “synchronize” (SYN) and “acknowledge” (ACK) in a TCP/IP transmission.

The term “in communication with” as used herein, refers to any coupling, connection, or interaction using electrical signals to exchange information or data, using any system, hardware, software, protocol, or format, regardless of whether the exchange occurs wirelessly or over a wired connection.

As used herein, the term “network” may include the Internet, a local area network, a wide area network, or combinations thereof. The network may include one or more networks or communication systems, such as the Internet, the telephone system, satellite networks, cable television networks, and various other private and public networks. In addition, the connections may include wired connections (such as wires, cables, fiber optic lines, etc.), wireless connections, or combinations thereof. Furthermore, although not shown, other computers, systems, devices, and networks may also be connected to the network. Network refers to any set of devices or subsystems connected by links joining (directly or indirectly) a set of terminal nodes sharing resources located on or provided by network nodes. The computers use common communication protocols over digital interconnections to communicate with each other. For example, subsystems may comprise the cloud. Cloud refers to servers that are accessed over the Internet, and the software and databases that run on those servers.

The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. For example, the computer readable storage medium can be, but is not limited to, an electronic storage device, a magnetic storage device, an optical storage device, an electromagnetic storage device, a superconducting storage device, and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, does not construe transitory signals per se, such as radio waves and/or other freely propagating electromagnetic waves, electromagnetic waves propagating through a waveguide and/or other transmission media (e.g., light pulses passing through a fiber optic cable), and/or electrical signals transmitted through a wire.

Computer readable program instructions described herein are downloadable to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field programmable gate arrays (FPGA), and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. Each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer-implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter described herein is in the general context of computer-executable instructions of a computer program product that runs on a computer and/or computers, those skilled in the art will recognize that the one or more embodiments herein also can be implemented in combination with one or more other program modules. Program modules include routines, programs, components, data structures, and/or the like that perform particular tasks and/or implement particular abstract data types. Moreover, other computer system configurations, including single-processor and/or multi-processor computer systems, mini-computing devices, mainframe computers, as well as computers, hand-held computing devices (e.g., PDA, phone), microprocessor-based or programmable consumer and/or industrial electronics and/or the like can practice the herein described computer-implemented methods. Distributed computing environments, in which remote processing devices linked through a communications network perform tasks, can also practice the illustrated aspects. However, stand-alone computers can practice one or more, if not all, aspects of the one or more embodiments described herein. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

As it is employed in the subject specification, the term “processor” can refer to any computing processing unit and/or device comprising, but not limited to, single-core processors; single-processors with software multi-thread execution capability; multi-core processors; multi-core processors with software multi-thread execution capability; multi-core processors with hardware multi-thread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches and/or gates, in order to optimize space usage and/or to enhance performance of related equipment. A combination of computing processing units can implement a processor.

Herein, terms such as “store,” “storage,” “data store,” data storage,” “database,” and any other information storage component relevant to operation and functionality of a component refer to “memory components,” entities embodied in a “memory,” or components comprising a memory. Memory and/or memory components described herein can be either volatile memory or non-volatile memory or can include both volatile and non-volatile memory. By way of illustration, and not limitation, non-volatile memory can include read-only memory (ROM), programmable ROM (PROM), electrically programmable ROM (EPROM), electrically erasable ROM (EEPROM), flash memory, and/or non-volatile random access memory (RAM) (e.g., ferroelectric RAM (FeRAM). Volatile memory can include RAM, which can function as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synch link DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein include, without being limited to including, these and/or any other suitable types of memory.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

Business problem 1: As the adoption of Electric Vehicles (EVs) increases, uncontrolled discharging of EV batteries to the grid during peak tariff periods leads to grid overloading and instability. The lack of a coordinated system to manage the discharge power from multiple EVs causes voltage fluctuations, frequency instability, and inefficient energy distribution, posing a threat to the overall grid infrastructure. There is a need for a dynamic control mechanism to manage EV discharging, prevent grid failures, and optimize power flow based on real-time grid conditions.

Business solution 1: The present system modifies the vehicle discharge power profile to prevent grid overloading during Vehicle-to-Grid (V2G) operations. The present system measures the real-time grid power profile using sensors and compares it with the reference grid power profile to identify deviations. By dynamically adjusting the vehicle discharge profile based on the deviation, the present system ensures optimal power flow, prevents voltage fluctuations, and maintains grid stability without causing overloading.

Technical problem 1: In Vehicle-to-Grid (V2G) technology, when multiple Electric Vehicles (EVs) discharge their battery power to the grid simultaneously during high-tariff periods, it leads to grid overloading, voltage instability, and frequency fluctuations. The existing V2G systems lack the capability to dynamically monitor the grid power profile, compare it with reference grid conditions, and control the discharge of EVs based on real-time deviations. As a result, uncontrolled discharging causes grid instability and inefficient energy management.

Technical Solution 1: In an aspect, a system for modifying the vehicle discharge power profile is implemented to prevent grid overloading and optimize power flow between EVs and the grid. The present system measures the real-time grid power profile using sensors, compares it with the reference grid power profile, and determines the deviation. By dynamically adjusting the vehicle discharge profile based on the deviation, the present system ensures optimal power flow, prevents voltage fluctuations, and maintains grid stability without causing overloading. Further, the present system selects one or more vehicles for discharging, groups the selected vehicles, and controls the discharging of the grouped vehicles to supply power to the grid (V2G) based on the deviation, thereby allowing dynamic control of multiple EVs to form a stable microgrid and send power to the grid only when needed.

Technical Result 1: The system manages the flow of power between the grid and electric vehicles, thereby reducing grid overloading, voltage fluctuations, and frequency instability. By dynamically modifying the vehicle discharge power profile, the system optimizes energy transfer, prevents unnecessary power loss, and enhances grid stability. Additionally, the system improves the efficiency of EV discharging operation, ensuring that power is drawn or supplied only when the grid demands it. This system enhances the lifespan of EV batteries while supporting grid reliability.

Technical Details Specific to the Technical Solution:

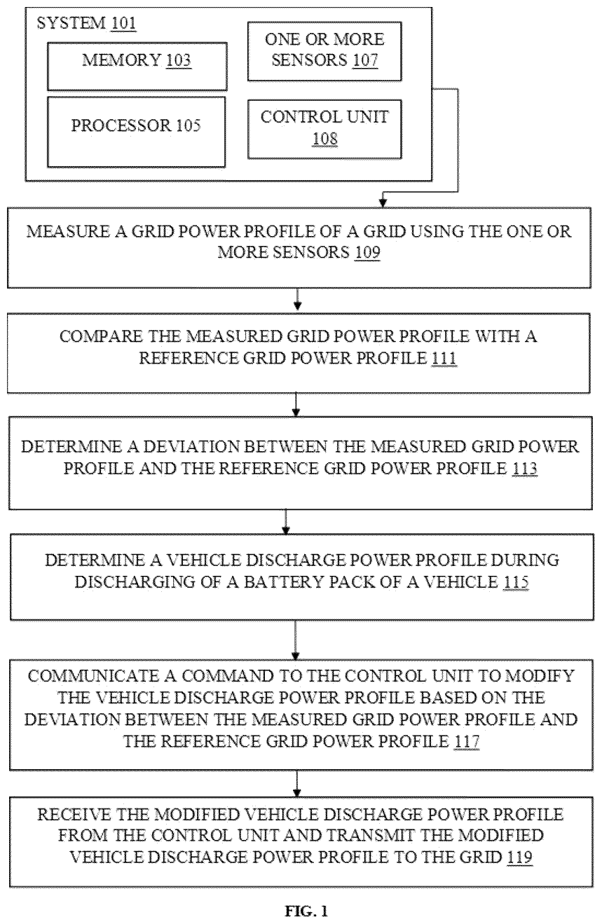

In an aspect, a system is described. As an example, FIG. 1 illustrates a system 101 for modifying a vehicle discharge power profile, according to one or more embodiments. The system 101 comprises: a memory 103, a processor 105, one or more sensors 107 and a control unit 108. The processor 105 communicatively coupled to the one or more sensors 107 and storing instructions in non-transitory memory that, when executed, causes the processor to measure a grid power profile of a grid using the one or more sensors 107 (at step 109); compare the measured grid power profile with a reference grid power profile (at step 111); determine a deviation between the measured grid power profile and the reference grid power profile (at step 113); determine a vehicle discharge power profile during discharging of a battery pack of a vehicle (at step 115); communicate a command to the control unit 108 to modify the vehicle discharge power profile based on the deviation between the measured grid power profile and the reference grid power profile (at step 117); and receive the modified vehicle discharge power profile from the control unit 108 and transmit the modified vehicle discharge power profile to the grid (at step 119).

In one embodiment, the grid power profile comprises a voltage profile, a current profile, a frequency profile, and a power quality profile. In one embodiment, the one or more sensors 107 comprise current sensors, voltage sensors, frequency sensors, and power quality sensors.

In one embodiment, the processor 105 is operable to measure the voltage profile by detecting fluctuations in power supply using voltage sensors.

In one embodiment, the processor 105 is operable to measure the current profile by monitoring a real-time flow of electrical current in the grid using current sensors.

In one embodiment, the processor 105 is operable to measure the frequency profile by measuring variations in grid frequency using frequency sensors.

In one embodiment, the processor 105 is operable to measure the power quality profile by analyzing harmonics, voltage fluctuations, phase imbalance, power factor, and total harmonic distortion (THD) using power quality sensors.

In one embodiment, the processor 105 is operable to modify the grid power profile according to specifications of the grid.

In one embodiment, the specifications of the grid comprise at least one of voltage range, frequency, phase configuration, power factor, load capacity, demand response, renewable energy support, grid stability, power quality, and fault tolerance.

In one embodiment, the system 101 comprises an artificial intelligence model. The artificial intelligence model may monitor and learn the reference grid power profile based on changes in time, seasonal demand patterns, and weather conditions and a count of registered electric vehicles (EVs) in a specific geographic area.

In one embodiment, the artificial intelligence model dynamically updates the reference grid power profile based on the learning.

In one embodiment, the processor 105 is operable to dynamically update the reference grid power profile based on an ideal grid power profile.

In one embodiment, the reference grid power profile is pre-stored in a database within the control unit 108.

In one embodiment, the processor 105 is operable to dynamically update the reference grid power profile based on historical and real-time grid data.

In one embodiment, the vehicle discharge power profile comprises a discharging voltage profile, a discharging current profile, a discharging frequency profile, and a discharging power quality profile.

In one embodiment, the processor 105 is operable to select one or more vehicles for discharging based on the modified vehicle discharge power profile.

In one embodiment, the processor 105 is operable to group the one or more selected vehicles for discharging based on discharge capacity, state of charge (SoC), state of Health (SoH) of the battery pack, environmental conditions, and the grid power profile.

In one embodiment, the processor 105 is operable to control the discharging of the grouped vehicles when the deviation between the grid power profile and the reference grid power profile exceeds a predefined threshold.

How Technical Solution is a Technological Advancement: The technical solution advances V2G technology by integrating real-time grid monitoring, deviation detection, and adaptive discharging control. Unlike conventional systems, this solution dynamically modifies the vehicle discharge power profile and regulates the discharge rate of multiple EVs simultaneously, thereby preventing grid overloading, stabilizing voltage and frequency fluctuations, and ensuring controlled power injection into the grid. By coordinating EV discharging based on real-time grid demand, the system enhances grid stability and optimizes energy distribution.

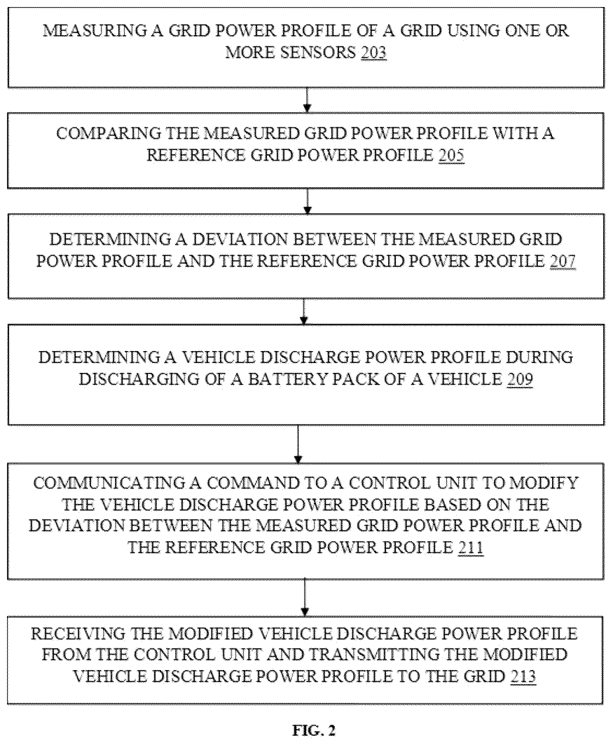

In one aspect, a method is described. As an example, FIG. 2 illustrates a method for modifying a vehicle discharge power profile according to one or more embodiments. The method comprises the following technical steps: measuring a grid power profile of a grid using one or more sensors (at step 203); comparing the measured grid power profile with a reference grid power profile (at step 205); determining a deviation between the measured grid power profile and the reference grid power profile (at step 207); determining a vehicle discharge power profile during discharging of a battery pack of a vehicle (at step 209); communicating a command to a control unit to modify the vehicle discharge power profile based on the deviation between the measured grid power profile and the reference grid power profile (at step 211); and receiving the modified vehicle discharge power profile from the control unit and transmitting the modified vehicle discharge power profile to the grid (at step 213).

In one embodiment, the grid power profile comprises a voltage profile, a current profile, a frequency profile, and a power quality profile.

In one embodiment, the method further comprises: measuring the voltage profile by detecting fluctuations in power supply using voltage sensors.

In one embodiment, the method further comprises: measuring the current profile by monitoring a real-time flow of electrical current in the grid using current sensors

In one embodiment, the method further comprises: measuring the frequency profile by measuring variations in grid frequency using frequency sensors.

In one embodiment, the method further comprises: measuring the power quality profile by analyzing harmonics, voltage fluctuations, phase imbalance, power factor, and total harmonic distortion (THD) using power quality sensors.

In one embodiment, the method further comprises: modifying the grid power profile according to specifications of the grid.

In one embodiment, the method further comprises: monitoring and learning, using an artificial intelligence model, the reference grid power profile based on changes in time, seasonal demand patterns, weather conditions and a count of registered electric vehicles (EVs) in a specific geographic area.

In one embodiment, the method further comprises: dynamically updating the reference grid power profile based on the learning of the artificial intelligence model.

In one embodiment, the method further comprises: dynamically updating the reference grid power profile based on an ideal grid power profile.

In one embodiment, the reference grid power profile is pre-stored in a database within the control unit.

In one embodiment, the method further comprises: dynamically updating the reference grid power profile based on historical and real-time grid data.

In one embodiment, the vehicle discharge power profile comprises a discharging voltage profile, a discharging current profile, a discharging frequency profile, and a discharging power quality profile.

In one embodiment, the method further comprises: selecting one or more vehicles for discharging based on the modified vehicle discharge power profile.

In one embodiment, the method further comprises: grouping the one or more selected vehicles for discharging based on discharge capacity, state of charge (SoC), state of Health (SoH) of the battery pack, environmental conditions, and the grid power profile.

In one embodiment, the method further comprises: controlling the discharging of the grouped vehicles when the deviation between the grid power profile and the reference grid power profile exceeds a predefined threshold.

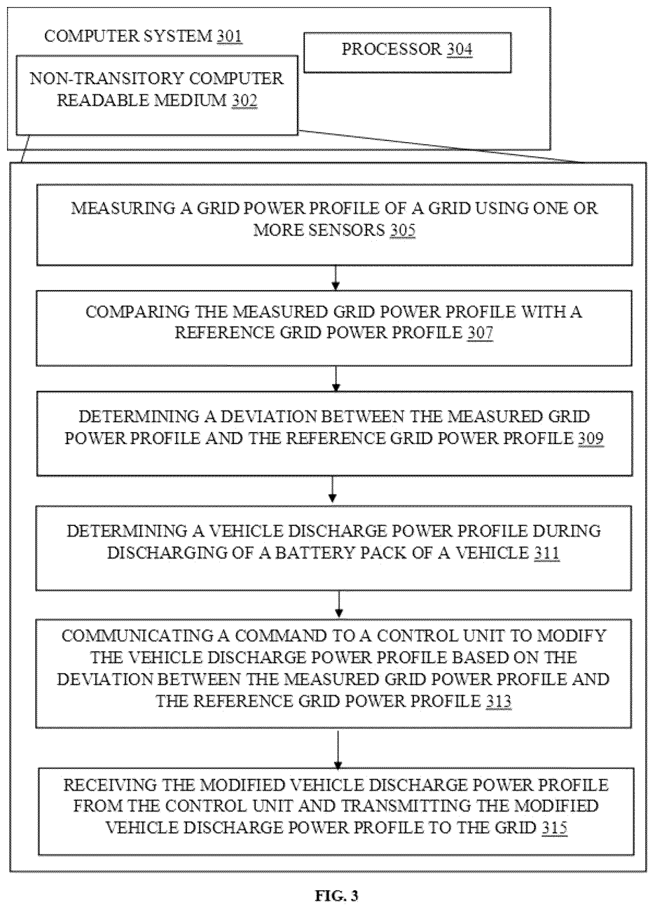

As an example, FIG. 3 illustrates a non-transitory computer readable storage medium for modifying a vehicle discharge power profile, according to one or more embodiments. According to an embodiment, disclosed is a computer system 301 comprising the non-transitory computer readable storage medium 302 having stored thereon instructions executable by a processor 304 to perform operations comprising: measuring a grid power profile of a grid using one or more sensors (at step 305); comparing the measured grid power profile with a reference grid power profile (at step 307); determining a deviation between the measured grid power profile and the reference grid power profile (at step 309); determining a vehicle discharge power profile during discharging of a battery pack of a vehicle (at step 311); communicating a command to a control unit to modify the vehicle discharge power profile based on the deviation between the measured grid power profile and the reference grid power profile (at step 313); and receiving the modified vehicle discharge power profile from the control unit and transmitting the modified vehicle discharge power profile to the grid (at step 315).

In one embodiment, the grid power profile comprises a voltage profile, a current profile, a frequency profile, and a power quality profile.

In one embodiment, the non-transitory computer readable storage medium 302 further causes: measuring the voltage profile by detecting fluctuations in power supply using voltage sensors.

In one embodiment, the non-transitory computer readable storage medium 302 further causes: measuring the current profile by monitoring a real-time flow of electrical current in the grid using current sensors.

In one embodiment, the non-transitory computer readable storage medium 302 further causes: measuring the frequency profile by measuring variations in grid frequency using frequency sensors.

In one embodiment, the non-transitory computer readable storage medium 302 further causes: measuring the power quality profile by analyzing harmonics, voltage fluctuations, phase imbalance, power factor, and total harmonic distortion (THD) using power quality sensors.

In one embodiment, the non-transitory computer readable storage medium 302 further causes: modifying the grid power profile according to specifications of the grid.

In one embodiment, the non-transitory computer readable storage medium 302 further causes: monitoring and learning, using an artificial intelligence model, the reference grid power profile based on changes in time, seasonal demand patterns, weather conditions and a count of registered electric vehicles (EVs) in a specific geographic area.

In one embodiment, the non-transitory computer readable storage medium 302 further causes: dynamically updating the reference grid power profile based on the learning of the artificial intelligence model.

In one embodiment, the non-transitory computer readable storage medium 302 further causes: dynamically updating the reference grid power profile based on an ideal grid power profile.

In one embodiment, the reference grid power profile is pre-stored in a database within the control unit.

In one embodiment, the non-transitory computer readable storage medium 302 further causes: dynamically updating the reference grid power profile based on historical and real-time grid data.

In one embodiment, the vehicle discharge power profile comprises a discharging voltage profile, a discharging current profile, a discharging frequency profile, and a discharging power quality profile.

In one embodiment, the non-transitory computer readable storage medium 302 further causes: selecting one or more vehicles for discharging based on the modified vehicle discharge power profile.

In one embodiment, the non-transitory computer readable storage medium 302 further causes: grouping the one or more selected vehicles for discharging based on discharge capacity, state of charge (SoC), state of Health (SoH) of the battery pack, environmental conditions, and the grid power profile.

In one embodiment, the non-transitory computer readable storage medium 302 further causes: controlling the discharging of the grouped vehicles when the deviation between the grid power profile and the reference grid power profile exceeds a predefined threshold.

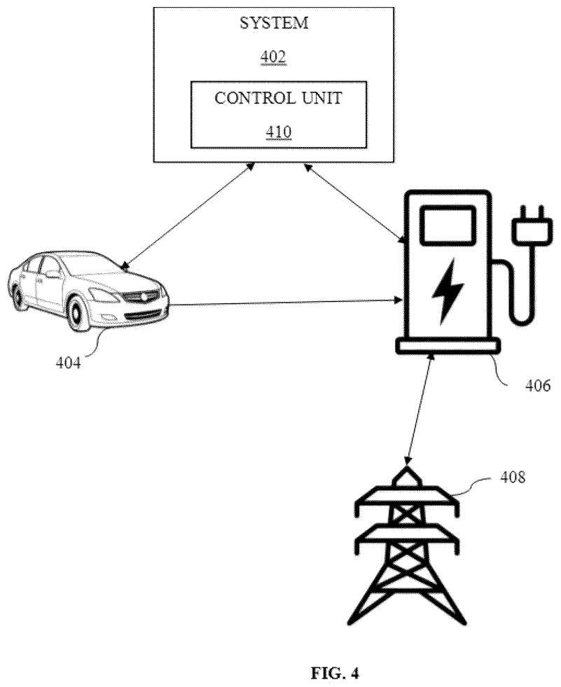

As an example, FIG. 4 illustrates a block diagram of a system 402 that modifies a vehicle discharge power profile according to one or more embodiments. The block diagram comprises the system 402, a vehicle 404, a wall-box charger 406 and a grid 408. The system 402 comprises a control unit 410. The vehicle 404 may be an electric vehicle and a hybrid vehicle. The vehicle 404 may be one of an autonomous vehicle, a semi-autonomous vehicle, and a non-autonomous vehicle. In one embodiment, the wall-box charger 406 enables bi-directional energy transfer, supporting both Grid-to-Vehicle (G2V) and Vehicle-to-Grid (V2G) operations. The wall-box charger 406 may be mounted on a wall or a dedicated charging post near parking spaces, garages, or charging stations. In one embodiment, the wall-box charger 406 is equipped with one or more sensors to monitor voltage, current, frequency, and power quality parameters during charging and discharging operations. In one embodiment, the system 402 communicates with the wall-box charger 406 over a wireless or cloud-based network to dynamically control power flow based on grid conditions. In one embodiment, the wall-box charger 406 comprises an energy storage unit to store excess power and supply it when required by the vehicle 404 or the grid 408.

The system 402 measures a grid power profile of a grid using the one or more sensors. The grid power profile may comprise a voltage profile, a current profile, a frequency profile, and a power quality profile. The one or more sensors may comprise current sensors, voltage sensors, frequency sensors and power quality sensors. In one embodiment, the voltage profile is measured using the voltage sensors that detect fluctuations in power supply. The voltage sensors may comprise capacitive voltage transformers (CVTs), resistive voltage dividers, or potential transformers (PTs), which continuously monitor voltage levels across the grid 408.

In one embodiment, the current profile is measured using the current sensors that monitor the real-time flow of electrical current. The current sensors may comprise shunt resistors, Hall effect sensors, or Rogowski coils, which are capable of measuring both alternating current (AC) and direct current (DC).

In one embodiment, the frequency profile is measured using the frequency sensors that analyze variations in grid frequency. These sensors may comprise phasor measurement units (PMUs), digital frequency meters, or phase-locked loop (PLL) circuits, which detect frequency fluctuations caused by sudden changes in load demand or generation output.

In one embodiment, the power quality profile is measured by analyzing harmonics, voltage fluctuations, phase imbalance, power factor, and total harmonic distortion (THD). The power quality sensors may comprise harmonic distortion analyzers, power quality meters, and phase imbalance detectors, which assess waveform distortions and irregularities in grid power.

The system 402 compares the measured grid power profile with a reference grid power profile. The reference grid power profile may act as a benchmark, representing expected grid conditions under normal operating scenarios. For example, if the measured grid voltage is 220V, but the reference voltage is 230V, the system 402 identifies a deviation between the measured grid voltage and the reference voltage.

In one embodiment, the system 402 dynamically updates the reference grid power profile based on historical and real-time grid data. The historical grid data may comprise records of voltage stability, frequency deviations, load variations, and grid disturbances collected over time. By analyzing these patterns, the system 402 can anticipate fluctuations and adjust the reference grid power profile. For example, if the historical grid data shows that grid voltage consistently drops during peak evening hours, the system 402 may update the reference voltage levels in advance to prevent instability. The system 402 continuously obtains real-time grid data by monitoring parameters such as voltage levels, frequency variations, and sudden load changes, allowing it to adjust the reference grid power profile. For example, if a sudden spike in demand is detected, the system 402 can dynamically adjust voltage and frequency setpoint to maintain stability and prevent outages.

The system 402 may dynamically update the reference grid power profile based on an ideal grid power profile. In one embodiment, the ideal grid power profile represents best-case operating conditions for the grid 408, where power distribution is efficient, and fluctuations are minimal. For example, in a renewable energy-integrated grid, the ideal grid power profile may adjust dynamically based on solar or wind power availability to ensure stable energy transfer.

In one embodiment, the reference grid power profile is pre-stored in a database within a control unit. In one embodiment, the reference grid power profile is stored and updated Over-the-Air (OTA) via a cloud-based control system. This allows grid operators to remotely configure and optimize grid settings based on real-time network conditions. For example, if a power plant failure occurs, the cloud-based system can modify the reference grid power profile to redistribute power and prevent system instability.

In one embodiment, the system 402 comprises an artificial intelligence (AI) model that updates the reference grid power profile. The AI model analyzes past and real-time grid data to detect patterns and predict changes that could affect grid stability. The AI model may use machine learning techniques to continuously improve its ability to make accurate predictions.

The AI model learns how the reference grid power profile changes over time by tracking factors such as changes in time, seasonal demand patterns, weather conditions and a count of registered electric vehicles (EVs) in a specific geographic area. For example, the AI model can use weather forecasts to predict how temperature changes affect electricity usage or analyze EV registration trends to estimate charging demand in the future. Based on these insights, the artificial intelligence model dynamically updates the reference grid power profile based on the learning. The AI model also processes real-time sensor data from the grid 408, allowing the system 402 to respond to sudden changes and improve overall efficiency.

The system 402 determines a vehicle discharge power profile during discharging of a battery pack of the vehicle 404. If a deviation is detected between the measured grid power profile and the reference grid power profile, the system 402 communicates a command to the control unit 410 to modify the vehicle discharge power profile accordingly. The vehicle discharge power profile may comprise a discharging voltage profile, a discharging current profile, a discharging frequency profile, and a discharging power quality profile.

In one embodiment, the discharging voltage profile ensures that the battery discharges at the correct voltage level to prevent grid instability. If the grid voltage drops due to high demand, the system 402 may instruct the control unit 410 to increase the discharge voltage within safe limits.

In one embodiment, the discharging current profile regulates the current flow from the battery to the grid 408. The system 402 ensures that the discharge current remains within the limits set by grid regulations and the vehicle's battery management system (BMS). For example, if the battery is rated for a maximum discharge current of 50 A, the system 402 ensures that current levels do not exceed this limit while dynamically adjusting based on real-time grid demand.

In one embodiment, the discharging frequency profile ensures that the discharged power maintains synchronization with the grid frequency, typically 50 Hz or 60 Hz depending on the region. If the system 402 detects a frequency deviation, such as a drop to 49.8 Hz due to an increase in the grid load, the system 402 may instruct the control unit 410 to discharge power at a slightly higher frequency to compensate. If the frequency exceeds 50.2 Hz due to excess generation, the system 402 may limit or stop discharge.

In one embodiment, the discharging power quality profile ensures that the power supplied by the vehicle 404 maintains waveform integrity, minimizing total harmonic distortion (THD), transient fluctuations, and phase imbalances. If the system 402 detects an increase in harmonic distortions beyond a threshold level (e.g., THD exceeding 5%), the system 402 may apply filtering techniques or adjust the discharge waveform to reduce harmonic interference. Additionally, the system 402 optimizes the power factor to remain close to unity (e.g., 0.98 to 1.0), ensuring efficient energy transfer and reducing energy losses in the grid 408.

In one embodiment, the system 402 modifies the grid power profile according to the specifications of the grid. The specifications of the grid 408 may comprise at least one of voltage range, frequency, phase configuration, power factor, load capacity, demand response, renewable energy support, grid stability, power quality, and fault tolerance.

In one embodiment, the voltage range specifies the acceptable operating voltage limits of the grid 408. For example, a low-voltage distribution grid may operate within 220V ±10%, while a high-voltage grid may require the voltage regulation within ±2%. If the grid voltage drops below the lower limit due to increased demand, the system 402 increases the vehicle's discharge voltage to compensate. Conversely, if the voltage exceeds the upper limit, the system 402 may reduce or stop discharge to prevent overvoltage.

In one embodiment, the frequency specification ensures that the grid 408 operates within a stable frequency range (e.g., 50 Hz±0.2 Hz in Europe or 60 Hz±0.1 Hz in North America). If an industrial load causes a frequency drop to 49.7 Hz, the system 402 modifies the discharge frequency from the vehicle battery to restore grid stability.

In one embodiment, the phase configuration defines how power is distributed across single-phase or three-phase grid systems. For example, a residential grid may use a single-phase 230V supply, while an industrial grid may require a balanced three-phase 400V system. The system 402 ensures that the vehicle 404 discharges power in the appropriate phase configuration based on the grid connection type.

In one embodiment, the power factor measures how efficiently the electrical power is utilized. A power factor close to 1.0 (unity) ensures minimal energy losses, while a lower power factor (e.g., 0.8) indicates inefficiencies. If the grid power factor drops due to inductive loads (e.g., large motors), the system 402 may adjust the vehicle's reactive power injection to improve power factor correction.

In one embodiment, the load capacity specifies the maximum power the grid 408 can handle. If a local transformer has a rated capacity of 500 kVA, the system 402 prevents the total discharge from exceeding this limit to avoid overloading grid infrastructure.

In one embodiment, the demand response capability allows the system 402 to dynamically adjust power output based on grid demand fluctuations. For example, during peak hours, the grid operator may request additional power injection, prompting the system 402 to increase vehicle discharge. During low-demand periods, the system 402 may reduce or store excess energy.

In one embodiment, the renewable energy support ensures compatibility with grids integrating solar, wind, or other renewable sources. If solar generation suddenly decreases due to cloud cover, the system 402 may compensate by increasing vehicle discharge to stabilize the grid 408.

In one embodiment, the grid stability specification ensures that power fluctuations are minimized. If a sudden load increase causes voltage dips, the system 402 may modify the discharge profile to provide rapid compensation and maintain stability.

In one embodiment, the power quality specification comprises parameters such as harmonic distortion, transient voltage variations, and waveform integrity. If harmonic distortion exceeds the acceptable limit (e.g., THD>5%), the system 402 may refine the discharge waveform to reduce interference.

In one embodiment, the fault tolerance capability allows the system 402 to respond to grid faults such as short circuits, frequency instability, or voltage sags. If a fault is detected, the system 402 may disconnect the vehicle 404 from the grid 408 or adjust discharge settings to support grid recovery.

Upon receiving the command, the control unit 410 dynamically modifies the vehicle discharge power profile to ensure efficient and stable energy transfer. In an embodiment, the control unit 410 implements an adaptive control algorithm to modify the vehicle discharge power profile. In one embodiment, a microcontroller (MCU) or digital signal processor (DSP) may run the adaptive control algorithm.

The control unit 410 processes the deviation between the measured and reference discharge power profiles and adjusts the vehicle's discharge voltage, current, frequency, and power quality accordingly. The control unit 410 may achieve this by controlling power electronic switches within the inverter, ensuring that the discharged power matches grid requirements. If frequency misalignment or harmonic distortion is detected, the control unit 410 implements real-time corrections to maintain grid stability and prevent unwanted disturbances. Once the modifications are applied, the control unit transmits the corrected discharge power profile to the grid.

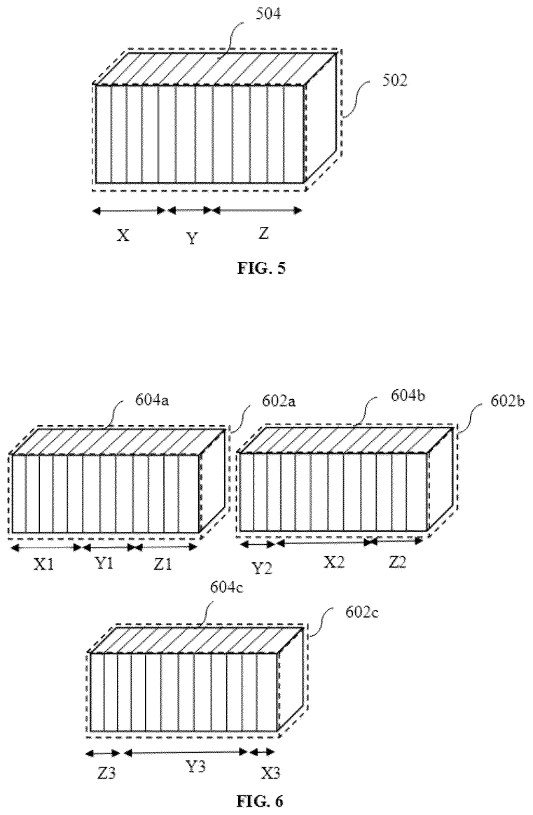

As an example, FIG. 5 illustrates a battery pack 502 comprising an individual battery, according to one or more embodiments. The battery pack 502 may be the battery within the charging station. In one embodiment, the battery pack 502 is within a vehicle. The battery pack 502 within the charging station is stationary and large enough to supply power to charge multiple vehicles simultaneously. The battery within the charging station is huge when compared to the battery within the electric vehicles. The battery pack 502 herein comprises an individual battery. The battery comprises a plurality of cells 504. The battery pack comprises a first portion X, a second portion Y, and a third portion Z. The first portion X may comprise a first plurality of cells among the plurality of cells of the battery. The second portion Y may comprise a second plurality of cells among the plurality of cells of the battery. The third portion Z may comprise a third plurality of cells among the plurality of cells of the battery.

The first portion X, the second portion Y, and the third portion Z may be categorized based on the state of health information at the respective portions. The first portion X may comprise a first state of health. The second portion Y may comprise a second state of health. The third portion Z may comprise a third state of health. In an embodiment, the first portion may refer to a portion of the battery having degraded cells. The second portion may refer to a portion of the battery having healthy cells. The third portion may refer to a portion of the battery having moderate degraded cells. The processor may be configured to detect the state of charge of the battery pack 502 having at least one of healthy cells, degraded cells, and moderate degraded cells.

As an example, FIG. 6 illustrates a battery pack comprising a plurality of batteries, according to one or more embodiments. The battery pack herein comprises a first battery 602a, a second battery 602b, and a third battery 602c. The first battery 602a may comprise a plurality of first cells 604a. The second battery 602b may comprise a plurality of second cells 604b. The third battery 602c may comprise a plurality of third cells 604c. Each battery of the battery pack is connected electrically to get charged. The charging station charges each battery of the battery pack. The charging station may charge each battery of the battery pack through at least one of randomly, serially, and parallelly.

The charging station may charge at least one of a first portion X, a second portion Y, and a third portion Z of the battery pack. The first portion X of the battery pack refers to degraded cells from one or more batteries of the battery pack (X=X1+X2+X3). The second portion Y of the battery pack refers to healthy cells from one or more batteries of the battery pack (Y=Y1+Y2+Y3). The third portion Z of the battery pack refers to moderate degraded cells from one or more batteries of the battery pack (Z=Z1+Z2+Z3). Healthy cells may be contiguous or non-contiguously located within the same battery. Similarly, degraded, and moderate degraded cells may be contiguous or non-contiguously located within the same battery. In one embodiment, the charging station may charge in combination of degraded cells, healthy cells, and moderate degraded cells from the one or more batteries.

The charging station is configured to map the battery pack based on the state of health information. In an embodiment, the charging station maps at least one of the degraded cells, the healthy cells, and the moderate degraded cells of the battery pack. The charging station, upon performing mapping the battery pack, computes the state of charge considering the state of health information.

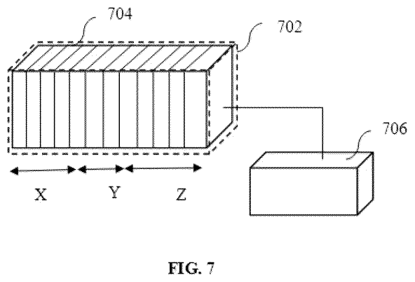

As an example, FIG. 7 schematically shows a battery pack comprising a battery 702 and a battery management system 706, according to one or more embodiments. The battery 702 in turn comprises a plurality of cells 704. The battery management system 706 may include a microprocessor, microcontroller, programmable digital signal processor, or another programmable device. The battery management system 706 may also or alternatively comprise an application specific integrated circuit, a programmable gate array or programmable array logic, a programmable logic device or a digital signal processor. Where the battery management system 706 comprises a programmable device such as the microprocessor, microcontroller or programmable digital signal processor mentioned above, the processor may also comprise computer-executable code which controls the operation of the programmable device. In an embodiment, the battery management system 706 resides within an electric vehicle. The battery management system 706 determines the state of charge (SoC) of the battery pack and communicates to the charging station via a vehicle computer system.

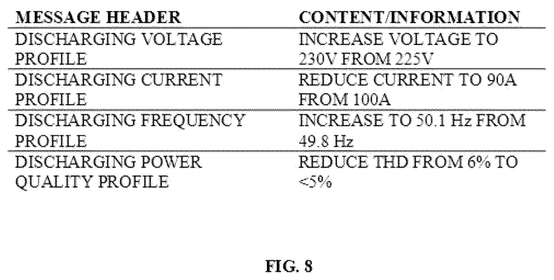

As an example, FIG. 8 illustrates an example command communicated from the system to modify a vehicle discharge power profile based on deviations between the measured grid power profile and the reference grid power profile, according to one or more embodiments. The system continuously monitors grid parameters such as voltage, current, frequency, and power quality. Upon detecting a deviation, the system analyzes the difference and generates the command to a control unit to adjust the vehicle discharge power profile accordingly. The generated command comprises discharging voltage profile, discharging current profile, discharging frequency profile, and discharging power quality profile, each containing specific adjustment values.

For example, if the system detects that the grid voltage has dropped from 230V to 220V, the system may generate the command to increase the vehicle's discharging voltage to 230V to stabilize the grid. If the grid frequency drops from 50 Hz to 49.6 Hz, the system may generate the command to adjust the vehicle's discharge frequency to 50 Hz to support frequency stability. Additionally, if the discharging current exceeds 100 A, the system may limit it to 90 A to prevent overloading. In the case of poor power quality, where total harmonic distortion (THD) exceeds 6%, the system may generate a command to modify the discharge waveform and reduce THD to below 5%.

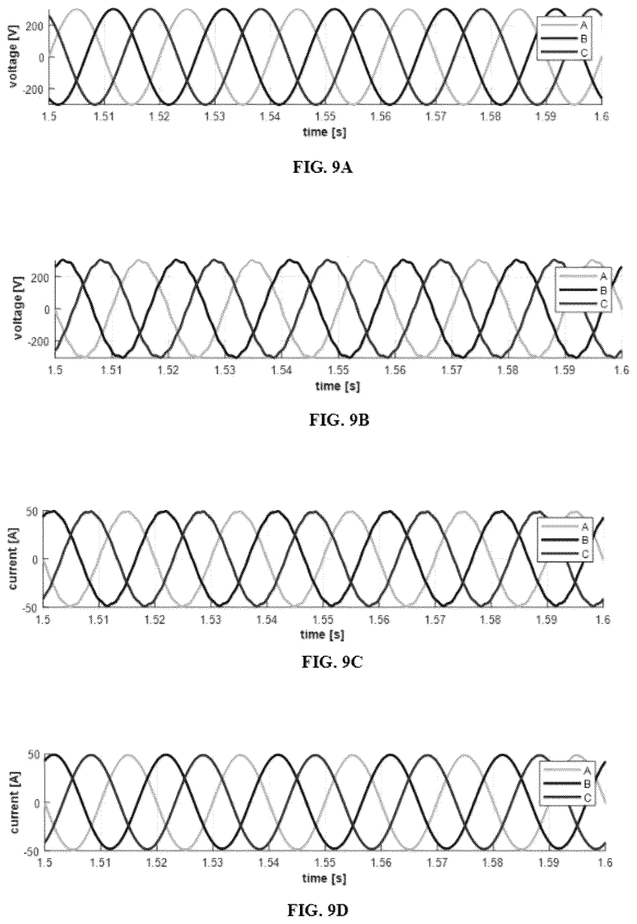

As an example, FIGS. 9A-9D illustrate a voltage profile and a current profile corresponding to Vehicle-to-Grid (V2G) operation, according to one or more embodiments. FIG. 9A represents the ideal reference grid voltage profile, showing balanced and undisturbed sinusoidal waveforms for three-phase voltages (A, B, and C). FIG. 9B illustrates a grid voltage profile, which comprises disturbances, noise, and deviations caused by external factors such as high penetration of intermittent renewable generation, sudden load changes, or grid disturbances. FIG. 9C depicts a noisy and distorted current profile, as measured from the grid. These distortions arise due to grid-side fluctuations, phase imbalances, and reactive power variations during V2G operations.

FIG. 9D shows the modified current profile obtained using an adaptive control algorithm implemented in the system. The adaptive control algorithm continuously compares the reference current profile and measured current profile. Based on the deviation, the system dynamically modifies the discharging current profile to align with grid stability requirements.

Business Problem 2: In Grid-to-Vehicle (G2V) charging, power drawn from the grid during off-peak periods leads to grid congestion and voltage fluctuations. The lack of a system to control and manage EV charging profiles based on real-time grid conditions results in inefficient power distribution and potential grid failures.

Business Solution 2: The present system modifies the grid power profile by monitoring real-time grid conditions, determining deviations, and adjusting the vehicle charging profile accordingly. The present system can select and group EVs for charging, control the charging rate, and ensure power is drawn from the grid only when the grid is stable. This approach prevents grid congestion, optimizes energy consumption, and supports efficient power management.

Technical problem 2: In Grid-to-Vehicle (G2V) technology, high-volume EV charging during low-tariff periods or high renewable energy generation leads to grid congestion and power quality degradation. Existing systems lack the ability to dynamically adjust the vehicle charging profile based on the real-time grid power profile, leading to inefficient power flow and grid instability.

Technical Solution 2: In an aspect, a system for modifying the grid power profile is implemented. The present system measures the real-time grid power profile using sensors, compares it with the reference grid power profile, and determines the deviation. Based on the deviation, the present system selects one or more vehicles for charging, groups the selected vehicles based on their charging capacity and state of charge (SoC), and controls the charging process to avoid grid instability. The present system modifies the grid power profile by optimizing energy transfer from the grid to the vehicles.

Technical Result 2: The system prevents grid congestion and voltage instability during G2V operations. By modifying the grid power profile in real-time, the system ensures stable power transfer, efficient grid utilization, and enhanced EV battery health.

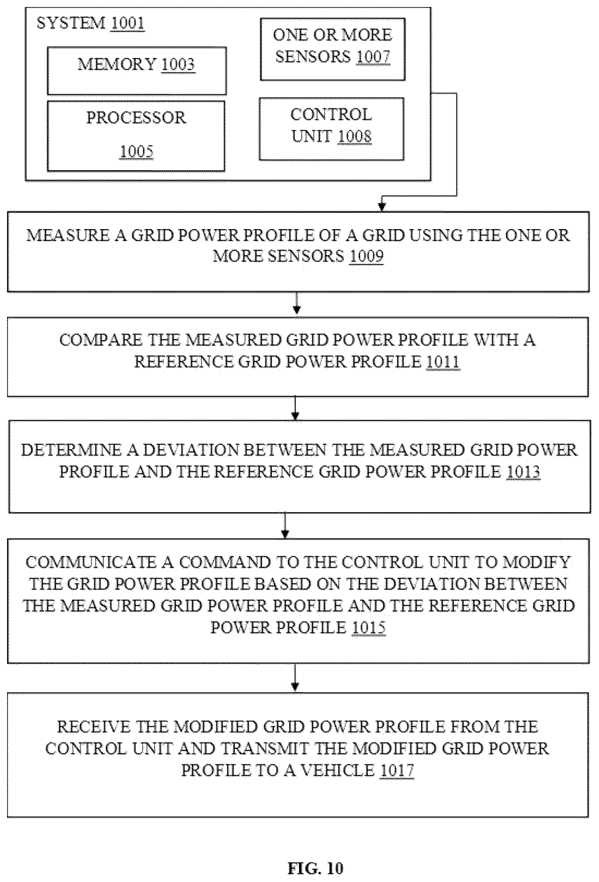

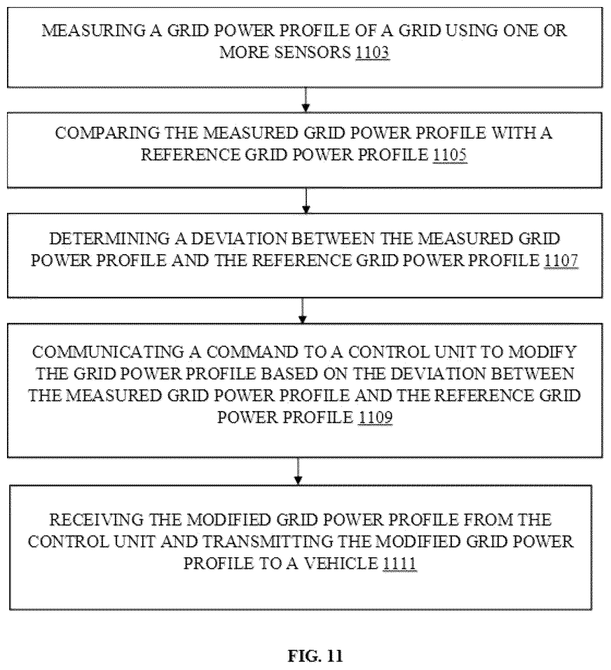

In an aspect, a system is described. As an example, FIG. 10 illustrates a system 1001 for modifying a grid power profile, according to one or more embodiments. The system 1001 comprises: a memory 1003, a processor 1005, one or more sensors 1007 and a control unit 1008. The processor 1005 communicatively coupled to the one or more sensors 1007 and storing instructions in non-transitory memory that, when executed, causes the processor to measure a grid power profile of a grid using the one or more sensors 1007 (at step 1009); compare the measured grid power profile with a reference grid power profile (at step 1011); determine a deviation between the measured grid power profile and the reference grid power profile (at step 1013); communicate a command to the control unit 1008 to modify the grid power profile based on the deviation between the measured grid power profile and the reference grid power profile (at step 1015); and receive the modified grid power profile from the control unit and transmit the modified grid power profile to a vehicle (at step 1017).

In one embodiment, the grid power profile comprises a voltage profile, a current profile, a frequency profile, and a power quality profile.

In one embodiment, the one or more sensors 1007 comprise current sensors, voltage sensors, frequency sensors, and power quality sensors. In one embodiment, the processor 1005 is operable to measure the voltage profile by detecting fluctuations in power supply using voltage sensors. In one embodiment, the processor 1005 is operable to measure the current profile by monitoring a real-time flow of electrical current in the grid using current sensors. In one embodiment, the processor 1005 is operable to measure the frequency profile by measuring variations in grid frequency using frequency sensors. In one embodiment, the processor 1005 is operable to measure the power quality profile by analyzing harmonics, voltage fluctuations, phase imbalance, power factor, and total harmonic distortion (THD) using power quality sensors. In one embodiment, the processor 1005 is operable to communicate a notification to a battery management system of the vehicle to perform charging of a battery pack of the vehicle based on the modified grid power profile.

In one embodiment, the processor 1005 is operable to modify the grid power profile according to specifications of the grid. The specifications of the grid may comprise at least one of voltage range, frequency, phase configuration, power factor, load capacity, demand response, renewable energy support, grid stability, power quality, and fault tolerance. The system 1001 may comprise an artificial intelligence model. In one embodiment, the artificial intelligence model monitors and learns the reference grid power profile based on changes in time, seasonal demand patterns, weather conditions and a count of registered electric vehicles (EVs) in a specific geographic area. The artificial intelligence model may dynamically update the reference grid power profile based on the learning.

In one embodiment, the reference grid power profile is pre-stored in a database within the control unit 1008. In one embodiment, the processor 1005 is operable to dynamically update the reference grid power profile based on historical and real-time grid data.

In one embodiment, the processor 1005 is operable to dynamically update the reference grid power profile based on an ideal grid power profile. In one embodiment, the processor 1005 is operable to select one or more vehicles for charging based on the modified grid power profile.

In one embodiment, the processor 1005 is operable to group the one or more selected vehicles for charging based on charging capacity, state of charge (SoC), state of Health (SoH) of a battery pack of a vehicle, environmental condition, and the grid power profile.

In one embodiment, the processor 1005 is operable to control the charging of the grouped vehicles when the deviation between the grid power profile and the reference grid power profile exceeds a predefined threshold.

How Technical Solution is a Technological Advancement: The present system advances G2V technology by integrating real-time grid monitoring, deviation detection, and adaptive charging control. Unlike conventional systems, this solution dynamically modifies the grid power profile and adjusts the charging rate of multiple EVs simultaneously, thereby preventing grid overload, optimizing energy flow, and enhancing grid stability.

In one aspect, a method is described. As an example, FIG. 11 illustrates a method for modifying a grid power profile according to one or more embodiments. The method comprises the following technical steps: measuring a grid power profile of a grid using one or more sensors (at step 1103); comparing the measured grid power profile with a reference grid power profile (at step 1105); determining a deviation between the measured grid power profile and the reference grid power profile (at step 1107); communicating a command to a control unit to modify the grid power profile based on the deviation between the measured grid power profile and the reference grid power profile (at step 1109); and receiving the modified grid power profile from the control unit and transmitting the modified grid power profile to a vehicle (at step 1111).

In one embodiment, the grid power profile comprises a voltage profile, a current profile, a frequency profile, and a power quality profile.

In one embodiment, the method further comprises: measuring the voltage profile by detecting fluctuations in power supply using voltage sensors.

In one embodiment, the method further comprises: measuring the current profile by monitoring a real-time flow of electrical current in the grid using current sensors.

In one embodiment, the method further comprises: measuring the frequency profile by measuring variations in grid frequency using frequency sensors.

In one embodiment, the method further comprises: measuring the power quality profile by analyzing harmonics, voltage fluctuations, phase imbalance, power factor, and total harmonic distortion (THD) using power quality sensors.

In one embodiment, the method further comprises: communicating a notification to a battery management system of a vehicle to perform charging of a battery pack of the vehicle based on the modified grid power profile.

In one embodiment, the method further comprises: modifying the grid power profile according to specifications of a specific grid.

In one embodiment, the method further comprises: monitoring and learning, using an artificial intelligence model, the reference grid power profile based on changes in time, seasonal demand patterns, weather conditions and a count of registered electric vehicles (EVs) in a specific geographic area.

In one embodiment, the method further comprises: dynamically updating the reference grid power profile based on the learning of the artificial intelligence model.

In one embodiment, the reference grid power profile is pre-stored in a database within the control unit.

In one embodiment, the method further comprises: dynamically updating the reference grid power profile based on historical and real-time grid data.

In one embodiment, the method further comprises: dynamically updating the reference grid power profile based on an ideal grid power profile.

In one embodiment, the method further comprises: selecting one or more vehicles for charging based on the modified grid power profile.

In one embodiment, the method further comprises: grouping the one or more selected vehicles for charging based on charging capacity, state of charge (SoC), state of Health (SoH) of a battery pack of a vehicle, environmental condition, and grid power profile.

In one embodiment, the method further comprises: controlling the charging of the grouped vehicles when the deviation between the grid power profile and the reference grid power profile exceeds a predefined threshold.

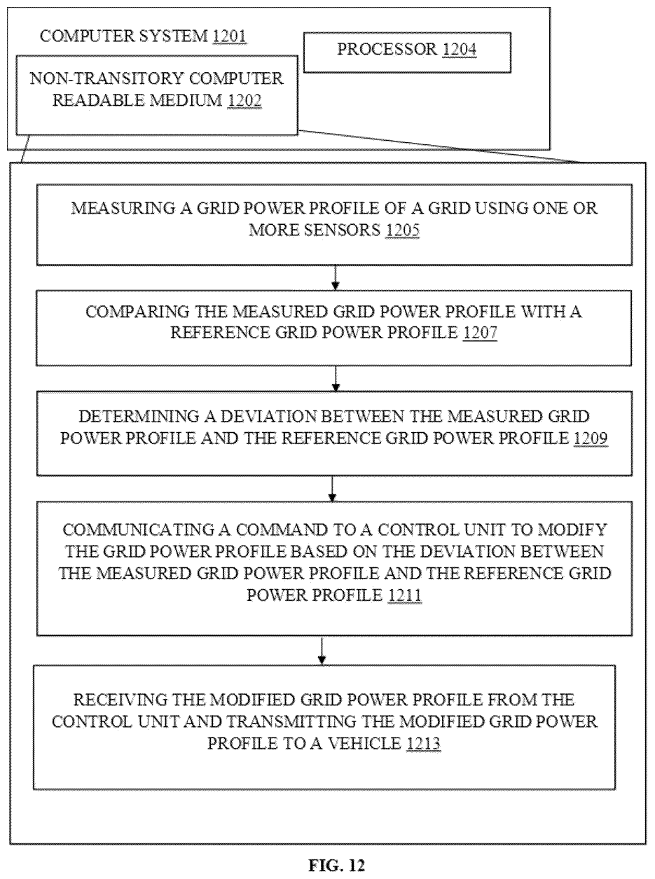

As an example, FIG. 12 illustrates a non-transitory computer readable storage medium for modifying a grid power profile, according to one or more embodiments. According to an embodiment, disclosed is a computer system 1201 comprising the non-transitory computer readable storage medium 1202 having stored thereon instructions executable by a processor 1204 to perform operations comprising: measuring a grid power profile of a grid using one or more sensors (at step 1205); comparing the measured grid power profile with a reference grid power profile (at step 1207); determining a deviation between the measured grid power profile and the reference grid power profile (at step 1209); communicating a command to a control unit to modify the grid power profile based on the deviation between the measured grid power profile and the reference grid power profile (at step 1211); and receiving the modified grid power profile from the control unit and transmit the modified grid power profile to a vehicle (at step 1213).

In one embodiment, the grid power profile comprises a voltage profile, a current profile, a frequency profile, and a power quality profile.

In one embodiment, the non-transitory computer readable storage medium 1202 further causes: measuring the voltage profile by detecting fluctuations in power supply using voltage sensors.

In one embodiment, the non-transitory computer readable storage medium 1202 further causes: measuring the current profile by monitoring a real-time flow of electrical current in the grid using current sensors.

In one embodiment, the non-transitory computer readable storage medium 1202 further causes: measuring the frequency profile by measuring variations in grid frequency using frequency sensors.

In one embodiment, the non-transitory computer readable storage medium 1202 further causes: measuring the power quality profile by analyzing harmonics, voltage fluctuations, phase imbalance, power factor, and total harmonic distortion (THD) using power quality sensors.

In one embodiment, the non-transitory computer readable storage medium 1202 further causes: communicating a notification to a battery management system of a vehicle to perform charging of a battery pack of the vehicle based on the modified grid power profile.

In one embodiment, the non-transitory computer readable storage medium 1202 further causes: modifying the grid power profile according to specifications of a specific grid.

In one embodiment, the non-transitory computer readable storage medium 1202 further causes: monitoring and learning, using an artificial intelligence model, the reference grid power profile based on changes in time, seasonal demand patterns, weather conditions and a count of registered electric vehicles (EVs) in a specific geographic area.

In one embodiment, the non-transitory computer readable storage medium 1202 further causes: dynamically updating the reference grid power profile based on the learning of the artificial intelligence model.

In one embodiment, the reference grid power profile is pre-stored in a database within the control unit.

In one embodiment, the non-transitory computer readable storage medium 1202 further causes: dynamically updating the reference grid power profile based on historical and real-time grid data.

In one embodiment, the non-transitory computer readable storage medium 1202 further causes: dynamically updating the reference grid power profile based on an ideal grid power profile.

In one embodiment, the non-transitory computer readable storage medium 1202 further causes: selecting one or more vehicles for charging based on the modified grid power profile.

In one embodiment, the non-transitory computer readable storage medium 1202 further causes: grouping the one or more selected vehicles for charging based on charging capacity, state of charge (SoC), state of Health (SoH) of a battery pack of a vehicle, environmental condition, and grid power profile.

In one embodiment, the non-transitory computer readable storage medium 1202 further causes: controlling the charging of the grouped vehicles when the deviation between the grid power profile and the reference grid power profile exceeds a predefined threshold.

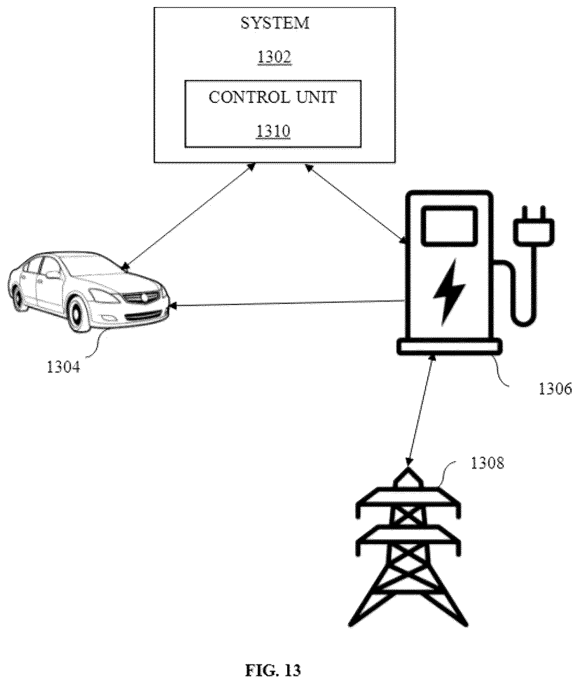

As an example, FIG. 13 illustrates a block diagram of a system 1302 that modifies a grid power profile according to one or more embodiments. The block diagram comprises the system 1302, a vehicle 1304, a wall-box charger 1306 and a grid 1308. The system 1302 comprises a control unit 1310.

The system 1302 measures a grid power profile of a grid using the one or more sensors. In an embodiment, the system 1302 implements an adaptive control algorithm. The grid power profile may comprise a voltage profile, a current profile, a frequency profile, and a power quality profile. The one or more sensors may comprise current sensors, voltage sensors, frequency sensors and power quality sensors. In one embodiment, the voltage profile is measured using the voltage sensors that detect fluctuations in power supply. The voltage sensors may comprise capacitive voltage transformers (CVTs), resistive voltage dividers, or potential transformers (PTs), which continuously monitor voltage levels across the grid 1308.

In one embodiment, the current profile is measured using the current sensors that monitor the real-time flow of electrical current. The current sensors may comprise shunt resistors, Hall effect sensors, or Rogowski coils, which are capable of measuring both alternating current (AC) and direct current (DC).

In one embodiment, the frequency profile is measured using the frequency sensors that analyze variations in grid frequency. These sensors may comprise phasor measurement units (PMUs), digital frequency meters, or phase-locked loop (PLL) circuits, which detect frequency fluctuations caused by sudden changes in load demand or generation output.

In one embodiment, the power quality profile is measured by analyzing harmonics, voltage fluctuations, phase imbalance, power factor, and total harmonic distortion (THD). The power quality sensors may comprise harmonic distortion analyzers, power quality meters, and phase imbalance detectors, which assess waveform distortions and irregularities in grid power.

The system 1302 compares the measured grid power profile with a reference grid power profile. The reference grid power profile may act as a benchmark, representing expected grid conditions under normal operating scenarios. For example, if the measured grid voltage is 220V, but the reference voltage is 230V, the system 1302 identifies a deviation between the measured grid voltage and the reference voltage.

In one embodiment, the system 1302 dynamically updates the reference grid power profile based on historical and real-time grid data. The historical grid data may comprise records of voltage stability, frequency deviations, load variations, and grid disturbances collected over time. By analyzing these patterns, the system 1302 can anticipate fluctuations and adjust the reference grid power profile.

The system 1302 continuously obtains real-time grid data by monitoring parameters such as voltage levels, frequency variations, and sudden load changes, allowing it to make adjustments to the reference grid power profile.

The system 1302 may dynamically update the reference grid power profile based on an ideal grid power profile. In one embodiment, the ideal grid power profile represents best-case operating conditions for the grid 1308, where power distribution is efficient, and fluctuations are minimal.

In one embodiment, the reference grid power profile is pre-stored in a database within a control unit. In one embodiment, the reference grid power profile is stored and updated Over-the-Air (OTA) via a cloud-based control system. This allows grid operators to remotely configure and optimize grid settings based on real-time network conditions.

In one embodiment, the system 1302 comprises an artificial intelligence (AI) model that updates the reference grid power profile. The AI model analyzes past and real-time grid data to detect patterns and predict changes that could affect grid stability. The AI model may use machine learning techniques to continuously improve its ability to make accurate predictions.

The AI model learns how the reference grid power profile changes over time by tracking factors such as changes in time, seasonal demand patterns, weather conditions and a count of registered electric vehicles (EVs) in a specific geographic area. Based on these insights, the artificial intelligence model dynamically updates the reference grid power profile based on the learning. The AI model also processes real-time sensor data from the grid 1308, allowing the system 1302 to respond to sudden changes and improve overall efficiency.

The system 1302 determines a deviation between the measured grid power profile and the reference grid power profile. The system 1302 communicates a command to the control unit 1310 to modify the grid power profile based on the deviation between the measured grid power profile and the reference grid power profile. For example, if the grid voltage is lower than the reference voltage due to high demand, the control unit 1310 may initiate corrective actions such as adjusting transformer tap settings, modifying reactive power compensation, or optimizing load distribution to stabilize the grid. Similarly, if excess renewable energy is available, the system 1302 may coordinate energy storage or increase vehicle charging to absorb surplus power.

In one embodiment, the system 1302 modifies the grid power profile according to the specifications of the grid. The specifications of the grid 1308 may comprise at least one of voltage range, frequency, phase configuration, power factor, load capacity, demand response, renewable energy support, grid stability, power quality, and fault tolerance.

Upon receiving the command, the control unit 1310 modifies the grid power profile to ensure efficient and stable energy transfer. The control unit 1310 modifies the grid power profile before supplying energy to the battery of the vehicle 1304. If deviations between the measured and reference grid power profiles are detected, the control unit 1310 regulates the charging voltage and current to ensure safe and efficient charging. It also monitors grid conditions to prevent overload scenarios and ensures that the charging process aligns with available grid capacity. Upon modifying the grid power profile, the control unit 1310 transmits the adjusted grid power profile to the vehicle 1304.

Further, the system 1302 communicates the notification to a battery management system of the vehicle 1304 to perform charging of a battery pack of the vehicle 1304 based on the modified grid power profile.

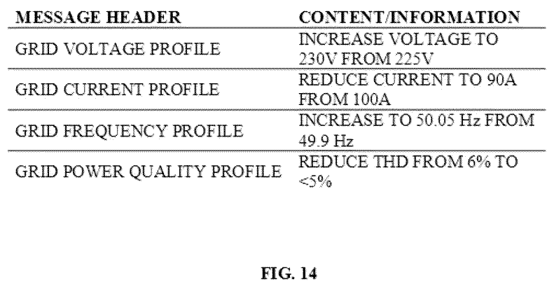

As an example, FIG. 14 illustrates an example command communicated to the control unit to modify the grid power profile based on the deviation between the measured grid power profile and the reference grid power profile according to one or more embodiments. Upon detecting the deviation, the system communicates the command to the control unit to modify the grid power profile. For example, if the measured grid voltage is lower than the reference voltage, the command instructs the control unit to increase the voltage from 225V to 230V to maintain stability. Similarly, if the measured grid current exceeds the reference value, the command reduces the current from 100 A to 95 A to prevent overloading. In cases where frequency fluctuations occur, the system commands an adjustment to increase the frequency from 49.9 Hz to 50.05 Hz, ensuring grid synchronization. Additionally, to enhance power quality, the system instructs a reduction in Total Harmonic Distortion (THD) from 6% to less than 5%, thereby improving efficiency and reducing electrical disturbances.

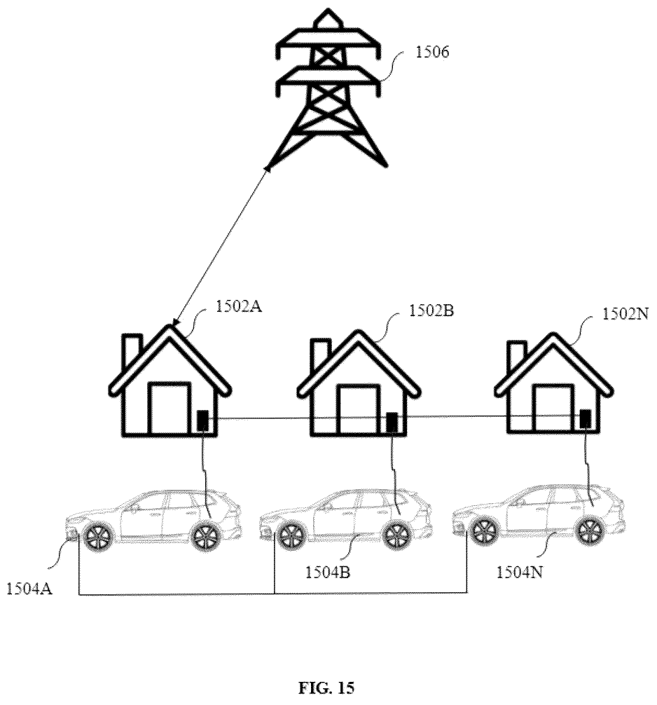

As an example, FIG. 15 illustrates a system in which one or more vehicles 1504A-N form a microgrid for bi-directional energy transfer, supporting both vehicle-to-grid (V2G) and grid-to-vehicle (G2V) operations, according to one or more embodiments. The system selects the one or more vehicles 1504A-N for either discharging or charging based on the modified vehicle discharge power profile or the modified grid power profile, respectively. The system may further group the selected vehicles 1504A-N based on discharge or charging capacity, state of charge (SoC), state of health (SoH) of the battery pack, environmental conditions, and the grid power profile.

As shown in FIG. 15, the one or more vehicles 1504A-N are connected to individual houses 1502A-N and linked to a grid 1506, enabling intelligent control for both discharging and charging processes. In an embodiment, the system utilizes AI-powered intelligent control to manage bi-directional energy flow, ensuring that power is transferred efficiently and only when required. The system may form a microgrid by grouping vehicles capable of discharging and charging based on their ability to contribute to grid stability, thus optimizing energy distribution. When the deviation between the measured grid power profile and the reference grid power profile exceeds a predefined threshold, the system controls the charging or discharging of the grouped vehicles to restore balance and maintain efficient energy utilization.

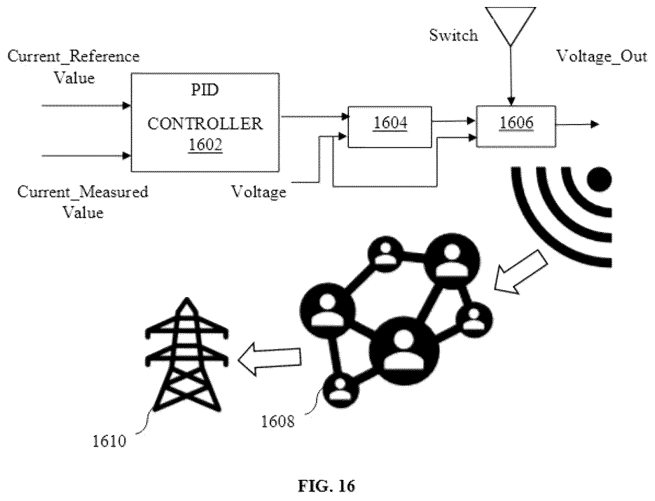

As an example, FIG. 16 illustrates a block diagram that illustrates transmitting a modified vehicle discharge power profile according to one or more embodiments. The block diagram comprises a Proportional-Integral-Derivative (PID) controller 1602, a summation or feedback adjustment unit 1604, a switching unit 1606, and a communication network for vehicle clustering. The system is designed to optimize energy transfer by dynamically modifying power profiles based on real-time grid conditions.

The PID controller 1602 determines the deviation between a current measured value and a current reference value, providing an error signal that indicates necessary adjustments. The summation or feedback adjustment unit 1604 integrates the PID controller's output with additional correction signals to ensure precise regulation of voltage, current, and power quality before reaching the switching unit 1606. This block compensates for disturbances such as voltage sags, frequency shifts, and harmonic distortions, ensuring stable energy transfer in both V2G and G2V modes.

Based on the processed deviation, the switching unit 1606 activates or deactivates accordingly. If required, the switching unit 1606 is turned on (1: On), allowing the control unit to modify the vehicle discharge power profile in V2G mode or the grid power profile in G2V mode. The control unit employs an adaptive control algorithm to modify the vehicle discharge power profile, dynamically regulates voltage, current, frequency, and overall power quality to maintain stable energy exchange between the vehicle and the grid. In one embodiment, a microcontroller (MCU) or digital signal processor (DSP) may run the adaptive control algorithm. If no modification is needed, the switching unit 1606 remains off (0: Off).

In V2G mode, the system determines the grid power profile, including voltage, current, frequency, and power quality, and compares it against the reference grid power profile, which may be pre-fed, updated over-the-air (OTA), or determined in real-time. If the measured grid power profile deviates from the reference profile, the switching unit 1606 is activated (1: On). Based on this, the control unit adjusts the discharge voltage and current by controlling power electronic switches (such as Metal Oxide Semiconductor Field-Effect Transistors (MOSFETs) and Insulated-Gate Bipolar Transistors (IGBTs)) within the DC-AC inverter. For example, if the expected discharge voltage is 230V AC but the measured voltage is 225V AC, the control unit increases the duty cycle of the inverter to raise the voltage accordingly. Additionally, the control unit may apply active filtering techniques to correct power factor and mitigate harmonic distortion, ensuring that the power fed into the grid meets regulatory standards. If the Total Harmonic Distortion (THD) exceeds a predefined threshold (e.g., 5%), the control unit dynamically modifies the switching pattern to minimize interference. The control unit also maintains phase and frequency synchronization with the grid to prevent power fluctuations and enhance grid stability. If no deviation is detected, the switching unit remains off (0: Off).

In G2V mode, the system determines the grid power profile and compares it with the reference grid power profile to regulate vehicle charging. The PID controller processes the deviation, and the summation block integrates additional corrections before passing the control signal to the switching unit. If the system detects a deviation requiring correction, the switching unit 1606 is turned on (1: On), allowing the control unit to modify the grid power profile before transmitting energy to the vehicle battery. If the grid voltage drops below the required level for safe charging, the switching unit increases the voltage accordingly. Similarly, it adjusts the current flow dynamically using power electronic switches such as MOSFETs or IGBTs to stabilize energy transfer. The system also improves power quality by applying active filtering techniques to reduce harmonic distortion. If THD exceeds acceptable limits, the switching frequency is dynamically modified to enhance power delivery to the vehicle. Additionally, the control unit maintains synchronization between the grid frequency and the vehicle's charging system, preventing deviations that could impact battery health and charging efficiency. If no correction is required, the switching unit remains off (0: Off).

Further, FIG. 16 illustrates how one or more vehicles 1608 can be clustered to form a microgrid, enabling optimized energy exchange with the grid 1610 for discharging (V2G mode). When vehicles operate in Vehicle-to-Grid (V2G) mode, they collectively supply power to the grid 1610 based on demand fluctuations. The system groups the one or more vehicles 1608 based on factors such as state of charge (SoC), state of health (SoH), and discharge capacity. When grid demand increases or a power imbalance is detected, the system selects and controls vehicle discharging to restore stability. By clustering the one or more vehicles, the system ensures a more reliable and consistent energy supply, preventing excessive depletion of any single vehicle's battery.

In Grid-to-Vehicle (G2V) mode, the system manages vehicle charging based on grid conditions. The one or more vehicles within the cluster draw power from the grid when conditions are optimal, ensuring efficient charging without overloading the grid. The system may prioritize charging for vehicles with lower SoC while reducing or pausing charging when grid demand is high. This system dynamic control helps prevent sudden load spikes and supports the integration of renewable energy by scheduling charging when excess energy is available.

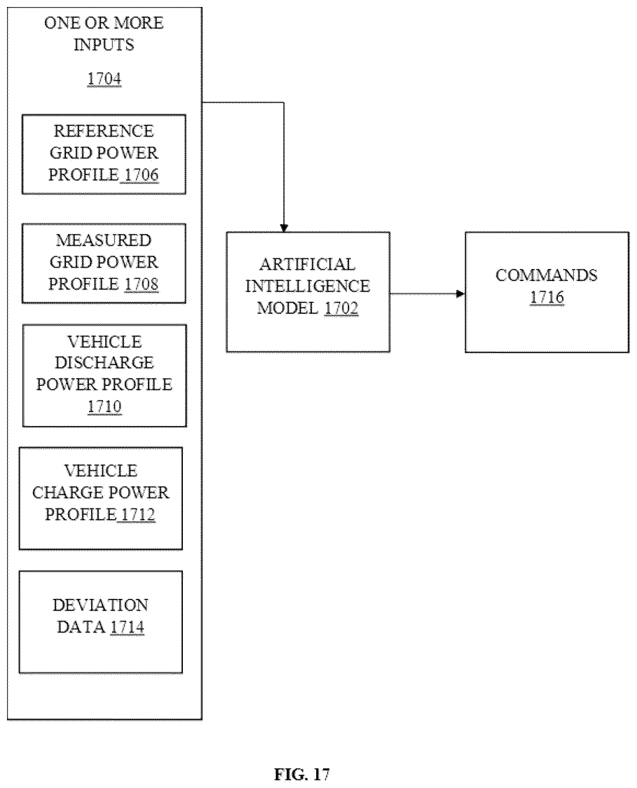

As an example, FIG. 17 illustrates a block diagram of an Artificial Intelligence (AI) model according to one or more embodiments. The block diagram comprises the Artificial Intelligence (AI) model 1702, one or more inputs 1704, and commands 1716. The one or more inputs 1704 comprises a reference grid power profile 1706, a measured grid power profile 1708, a vehicle discharge power profile 1710, a vehicle charge power profile 1712 and deviation data 1714. These inputs provide the AI model with real-time and historical data related to grid and vehicle energy exchange.

The reference grid power profile 1706 represents the expected or target values for grid voltage, current, frequency, and power quality. The measured grid power profile 1708 provides real-time data on the actual grid conditions, capturing any fluctuations or disturbances. The vehicle discharge power profile 1710 comprises information about the power being supplied from the electric vehicle (EV) to the grid in vehicle-to-grid (V2G) mode, while the vehicle charger power profile 1712 represents the power drawn from the grid for charging the EV in grid-to-vehicle (G2V) mode. The deviation data 1714 represents the difference between the expected and actual power profiles, helping to identify inconsistencies in the energy transfer process.

The AI model 1702 processes these inputs to generate commands 1716. These commands control power electronic switches, such as MOSFETs and IGBTs, to fine-tune voltage, current, and frequency for seamless energy exchange between the vehicle and the grid. The AI model also applies predictive analytics and adaptive control strategies to ensure efficient energy transfer, improve power quality, and mitigate harmonic distortion. Additionally, it enhances grid stability by maintaining synchronization between the EV and the grid. The generated commands help regulate energy flow in both charging (G2V) and discharging (V2G) modes, optimizing power distribution based on real-time grid demand and vehicle battery conditions.

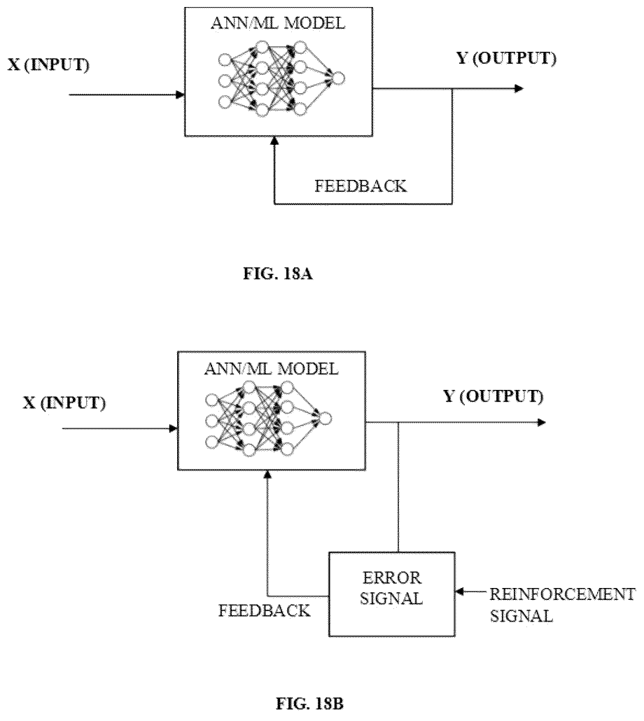

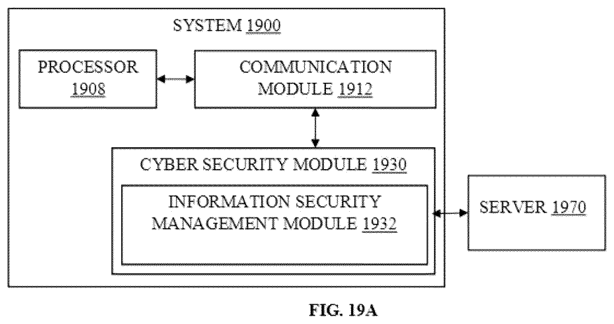

As an example, FIG. 18A shows a structure of the neural network/machine learning model with a feedback loop. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data, make a prediction on that input data, and then provide a response. The model may learn from the data. Learning can be supervised learning and/or unsupervised learning and may be based on different scenarios and with different datasets. Supervised learning comprises logic using at least one of a decision tree, logistic regression, and support vector machines. Unsupervised learning comprises logic using at least one of a k-means clustering, a hierarchical clustering, a hidden Markov model, and an a priori algorithm. The output layer may communicate a command to the battery management system to perform one of charging and discharging.

In an embodiment, ANNs may be a Deep-Neural Network (DNN), which is a multilayer tandem neural network comprising Artificial Neural Networks (ANN), Convolution Neural Networks (CNN) and Recurrent Neural Networks (RNN). Neural Networks can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, and image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the model through the feedback (error signal). The variations of weights in the hidden layer(s) will be adjusted to fit the expected outputs better while training the model. This will allow the model to provide results with far fewer mistakes.

The neural network is featured with the feedback loop to adjust the system output dynamically as it learns from the new data. In machine learning, backpropagation and feedback loops are used to train an AI model and continuously improve it upon usage. As the incoming data that the model receives increases, there are more opportunities for the model to learn from the data. The feedback loops, or backpropagation algorithms, identify inconsistencies and feed the corrected information back into the model as an input.

Even though the Artificial Intelligence/Machine Learning (AI/ML) model is trained well, with large sets of labelled data and concepts, after a while, the models' performance may decline while adding new, unlabelled input due to many reasons which include, but not limited to, concept drift, recall precision degradation due to drifting away from true positives, and data drift over time. A feedback loop in the model keeps the AI results accurate and ensures that the model maintains its performance and improvement, even when new unlabelled data is assimilated. A feedback loop refers to the process by which an AI model's predicted output is reused to train new versions of the model.

Initially, when the AI/ML model is trained, a few labelled samples comprising both positive and negative examples of the concepts (for e.g., determining a deviation between the measured grid power profile and the reference grid power profile and modifying the vehicle discharge power profile or grid power profile based on the deviation, etc.) are used that are meant for the model to learn. Afterward, the model is tested using unlabelled data. By using, for example, deep learning and neural networks, the model can then make predictions on whether the desired concept/s (for e.g., determining a deviation between the measured grid power profile and the reference grid power profile and modify the vehicle discharge power profile or grid power profile based on the deviation, etc.) are in unlabelled images. Each image is given a probability score where higher scores represent a higher level of confidence in the models' predictions. Where a model gives an image a high probability score, it is auto-labelled with the predicted concept. However, in the cases where the model returns a low probability score, this input may be sent to a controller (may be a human moderator) which verifies and, as necessary, corrects the result. The human moderator may be used only in exception cases. The feedback loop feeds labelled data, auto-labelled or controller-verified, back to the model dynamically and is used as training data so that the system can improve its predictions in real-time and dynamically.

As an example, FIG. 18B shows a structure of the neural network/machine learning model with reinforcement learning. The network receives feedback from authorized networked environments. Though the system is similar to supervised learning, the feedback obtained in this case is evaluative not instructive, which means there is no teacher as in supervised learning. After receiving the feedback, the network performs adjustments of the weights to get better predictions in the future. Machine learning techniques, like deep learning, allow models to take labelled training data and learn to recognize those concepts in subsequent data and images. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time.

In an embodiment, icons on a graphical user interface (GUI) or display of the infotainment system of a computer system are re-arranged based on a priority score of the content of the message. The processor tracks the messages that need to be displayed at a given time and generates a priority score, wherein the priority score is determined based on the action that needs to be taken by the user, the time available before the user input is needed, content of the message to be displayed, criticality of the user's input/action that needs to be taken, the sequence of the message or messages that need to be displayed and executed, and the safety of the overall scenario. For example, in case of a health emergency, the messages in queue for displaying could be an emergency signal, type of emergency, intimation that an alert is provided to the nearby vehicles, instructing a path for the driver to pull over, calling the emergency services, etc. In all these messages that need a driver's attention, a priority score is provided based on the actions that need to be taken by the user, the time available for the user to receive the displayed message and react with an action, the content of the message, criticality of the user's input/action, sequence of the messages that need to be executed, and safety of the overall scenario. Considering the above example, the message that intimates the user/driver that an alert has been provided to nearby vehicles may be of lower priority as compared to instructing the path for the driver to pull over. Therefore, the pull over directions for the path message takes priority and takes such a place on the display (example, center of the display) which can grab the users' attention immediately. The priority of the messages is evaluated dynamically as the situation is evolving and thus the display icons, positions, and sizes of the text or icon on the display are changed in real-time and dynamically. In an embodiment, more than one message is displayed and highlighted as per the situation and the user's actions. Further, while pulling over, if an unsafe scenario is found, for example, a car is changing lanes which may obstruct the user's vehicle, the message dynamically changes and warns the driver about the developing scenario. In another scenario of a vehicle with charge less than threshold charge level, the processor dynamically reassigns the priority score and depicts nearby charging station and navigates the route to the charging station onto a display in the dashboard.

In an embodiment, the system further comprises a cyber security module wherein the cyber security module comprises an information security management module providing isolation between the communication module and servers.

In an embodiment, the information security management module is operable to, receive data from the communication module, exchange a security key at a start of the communication between the communication module and the server, receive the security key from the server, authenticate an identity of the server by verifying the security key, analyze the security key for a potential cyber security threat, negotiate an encryption key between the communication module and the server, encrypt the data; and transmit the encrypted data to the server when no cyber security threat is detected.

In an embodiment, the information security management module is operable to exchange a security key at a start of the communication between the communication module and the server, receive the security key from the server, authenticate an identity of the server by verifying the security key, analyze the security key for a potential cyber security threat, negotiate an encryption key between the system and the server, receive encrypted data from the server, decrypt the encrypted data, perform an integrity check of the decrypted data and transmit the decrypted data to the communication module when no cyber security threat is detected.

In an embodiment, the system may comprise a cyber security module.

In one aspect, a secure communication management (SCM) computer device for providing secure data connections is provided. The SCM computer device includes a processor in communication with memory. The processor is programmed to receive, from a first device, a first data message. The first data message is in a standardized data format. The processor is also programmed to analyze the first data message for potential cyber security threats. If the determination is that the first data message does not contain a cyber security threat, the processor is further programmed to convert the first data message into a first data format associated with the vehicle environment and transmit the converted first data message to the vehicle system using a first communication protocol associated with the vehicle system.

According to an embodiment, secure authentication for data transmissions comprises, provisioning a hardware-based security engine (HSE) located in the information security management module, said HSE having been manufactured in a secure environment and certified in said secure environment as part of an approved network; performing asynchronous authentication, validation and encryption of data using said HSE, storing user permissions data and connection status data in an access control list used to define allowable data communications paths of said approved network, enabling communications of the communications system with other computing system subjects to said access control list, performing asynchronous validation and encryption of data using security engine including identifying a user device (UD) that incorporates credentials embodied in hardware using a hardware-based module provisioned with one or more security aspects for securing the system, wherein security aspects comprising said hardware-based module communicating with a user of said user device and said HSE.

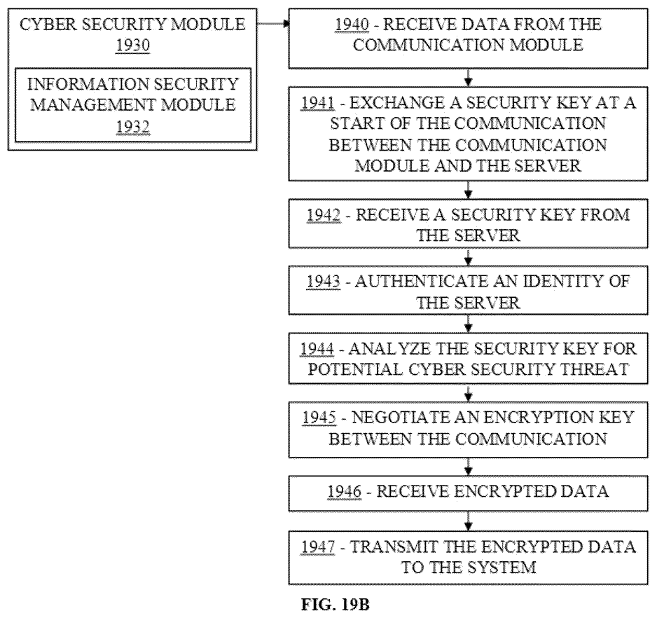

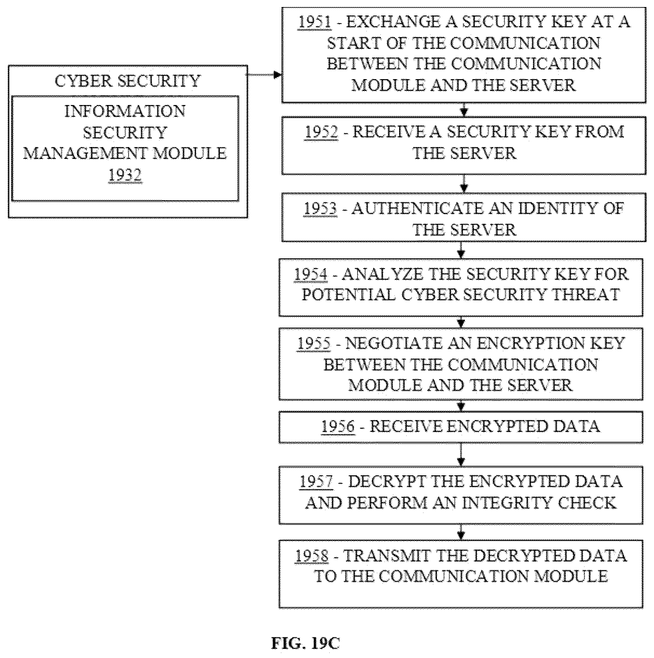

In an embodiment, FIG. 19A shows the block diagram of the cyber security module. The communication of data between the system 1900 and the server 1970, through the processor 1908, through the communication module 1912, is first verified by the information security management module 1932 before being transmitted from the system to the server or from the server to the system. The information security management module is operable to analyze the data for potential cyber security threats, to encrypt the data when no cyber security threat is detected, and to transmit the data encrypted to the system or the server.

In an embodiment, the cyber security module further comprises an information security management module providing isolation between the system and the server. FIG. 19B shows the flowchart of securing the data through the cyber security module 1930. At step 1940, the information security management module 1932 is operable to receive data from the communication module. At step 1941, the information security management module exchanges a security key at a start of the communication between the communication module and the server. At step 1942, the information security management module receives a security key from the server. At step 1943, the information security management module authenticates an identity of the server by verifying the security key. At step 1944, the information security management module analyzes the security key for potential cyber security threats. At step 1945, the information security management module negotiates an encryption key between the communication module and the server. At step 1946, the information security management module receives the encrypted data. At step 1947, the information security management module transmits the encrypted data to the server when no cyber security threat is detected.

In an embodiment, FIG. 19C shows the flowchart of securing the data through the cyber security module 1930. At step 1951, the information security management module 1932 is operable to: exchange a security key at a start of the communication between the communication module and the server. At step 1952, the information security management module receives a security key from the server. At step 1953, the information security management module authenticates an identity of the server by verifying the security key. At step 1954, the information security management module analyzes the security key for potential cyber security threats. At step 1955, the information security management module negotiates an encryption key between the communication module and the server. At step 1956, the information security management module receives encrypted data. At step 1957, the information security management module decrypts the encrypted data, and performs an integrity check of the decrypted data. At step 1958, the information security management module transmits the decrypted data to the communication module when no cyber security threat is detected.

In an embodiment, the integrity check is a hash-signature verification using a Secure Hash Algorithm 256 (SHA256) or a similar method.

In an embodiment, the information security management module is configured to perform asynchronous authentication and validation of the communication between the communication module and the server.

In an embodiment, the information security management module is configured to raise an alarm if a cyber security threat is detected. In an embodiment, the information security management module is configured to discard the encrypted data received if the integrity check of the encrypted data fails.

In an embodiment, the information security management module is configured to check the integrity of the decrypted data by checking accuracy, consistency, and any possible data loss during the communication through the communication module.

In an embodiment, the server is physically isolated from the system through the information security management module. When the system communicates with the server as shown in FIG. 19A, identity authentication is first carried out on the system and the server. The system is responsible for communicating/exchanging a public key of the system and a signature of the public key with the server. The public key of the system and the signature of the public key are sent to the information security management module. The information security management module decrypts the signature and verifies whether the decrypted public key is consistent with the received original public key or not. If the decrypted public key is verified, the identity authentication is passed. Similarly, the system and the server carry out identity authentication on the information security management module. After the identity authentication is passed on to the information security management module, the two communication parties, the system, and the server, negotiate an encryption key and an integrity check key for data communication of the two communication parties through the authenticated asymmetric key. A session ID number is transmitted in the identity authentication process, so that the key needs to be bound with the session ID number; when the system sends data to the outside, the information security gateway receives the data through the communication module, performs integrity authentication on the data, then encrypts the data through a negotiated secret key, and finally transmits the data to the server through the communication module. When the information security management module receives data through the communication module, the data is decrypted first, integrity verification is carried out on the data after decryption, and if verification is passed, the data is sent out through the communication module; otherwise, the data is discarded.

In an embodiment, the identity authentication is realized by adopting an asymmetric key with a signature.

In an embodiment, the signature is realized by a pair of asymmetric keys which are trusted by the information security management module and the system, wherein the private key is used for signing the identities of the two communication parties, and the public key is used for verifying that the identities of the two communication parties are signed. Signing identity comprises a public and a private key pair. In other words, signing identity is referred to as the common name of the certificates which are installed in the user's machine.

In an embodiment, both communication parties need to authenticate their own identities through a pair of asymmetric keys, and a task in charge of communication with the information security management module of the system is identified by a unique pair of asymmetric keys.

In an embodiment, the dynamic negotiation key is encrypted by adopting a Rivest-Shamir-Adleman (RSA) encryption algorithm. RSA is a public key cryptosystem that is widely used for secure data transmission. The negotiated keys include a data encryption key and a data integrity check key.

In an embodiment, the data encryption method is a Triple Data Encryption Algorithm (3DES) encryption algorithm. The integrity check algorithm is a Hash-based Message Authentication Code (HMAC-MD5-128) algorithm. When data is output, the integrity check calculation is carried out on the data, the calculated Message Authentication Code (MAC) value is added with the header of the value data message, then the data (including the MAC of the header) is encrypted by using a 3DES algorithm, the header information of a security layer is added after the data is encrypted, and then the data is sent to the next layer for processing. In an embodiment the next layer refers to a transport layer in the Transmission Control Protocol/Internet Protocol (TCP/IP) model.

The information security management module ensures the safety, reliability, and confidentiality of the communication between the system and the server through the identity authentication when the communication between the two communication parties starts the data encryption and the data integrity authentication. The method is particularly suitable for an embedded platform which has less resources and is not connected with a Public Key Infrastructure (PKI) system and can ensure that the safety of the data on the server cannot be compromised by a hacker attack under the condition of the Internet by ensuring the safety and reliability of the communication between the system and the server.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

Other specific forms may embody the present disclosure without departing from its spirit or characteristics. The described embodiments are in all respects illustrative and not restrictive. Therefore, the appended claims rather than the description herein indicate the scope of the disclosure. All variations which come within the meaning and range of equivalency of the claims are within their scope.

1-102. (canceled)

103. A system, comprising:
one or more sensors;
a control unit; and
a processor, communicatively coupled to the one or more sensors and storing instructions in non-transitory memory that, when executed, causes the processor to:
measure a grid power profile of a grid using the one or more sensors;
compare the measured grid power profile with a reference grid power profile;
determine a deviation between the measured grid power profile and the reference grid power profile;
determine a vehicle discharge power profile during discharging of a battery pack of a vehicle;
communicate a command to the control unit to modify the vehicle discharge power profile based on the deviation between the measured grid power profile and the reference grid power profile; and
receive the modified vehicle discharge power profile from the control unit and transmit the modified vehicle discharge power profile to the grid.

104. The system of claim 103, wherein the grid power profile comprises a voltage profile, a current profile, a frequency profile, and a power quality profile.

105. The system of claim 103, wherein the one or more sensors comprise current sensors, voltage sensors, frequency sensors, and power quality sensors.

106. The system of claim 104, wherein the processor is operable to measure the voltage profile by detecting fluctuations in power supply using voltage sensors.

107. The system of claim 104, wherein the processor is operable to measure the current profile by monitoring a real-time flow of electrical current in the grid using current sensors.

108. The system of claim 104, wherein the processor is operable to measure the frequency profile by measuring variations in grid frequency using frequency sensors.

109. The system of claim 104, wherein the processor is operable to measure the power quality profile by analyzing harmonics, voltage fluctuations, phase imbalance, power factor, and total harmonic distortion (THD) using power quality sensors.

110. The system of claim 103, wherein the vehicle discharge power profile comprises a discharging voltage profile, a discharging current profile, a discharging frequency profile, and a discharging power quality profile.

111. The system of claim 103, wherein the system comprises an artificial intelligence model that monitors and learns the reference grid power profile based on changes in time, seasonal demand patterns, weather conditions and a count of registered electric vehicles (EVs) in a specific geographic area.

112. The system of claim 111, wherein the artificial intelligence model dynamically updates the reference grid power profile based on the learning.

113. A method comprising:
measuring a grid power profile of a grid using one or more sensors;
comparing the measured grid power profile with a reference grid power profile;
determining a deviation between the measured grid power profile and the reference grid power profile;
determining a vehicle discharge power profile during discharging of a battery pack of a vehicle;
communicating a command to a control unit to modify the vehicle discharge power profile based on the deviation between the measured grid power profile and the reference grid power profile; and
receiving the modified vehicle discharge power profile from the control unit and transmitting the modified vehicle discharge power profile to the grid.

114. The method of claim 113, further comprising: dynamically updating the reference grid power profile based on an ideal grid power profile.

115. The method of claim 113, wherein the reference grid power profile is pre-stored in a database within the control unit.

116. The method of claim 113, further comprising: dynamically updating the reference grid power profile based on historical and real-time grid data.

117. The method of claim 113, further comprising: modifying the grid power profile according to specifications of the grid that comprise at least one of voltage range, frequency, phase configuration, power factor, load capacity, demand response, renewable energy support, grid stability, power quality, and fault tolerance.

118. A non-transitory computer readable storage medium comprising:
a sequence of instructions, which when executed by a processor causes the processor to:
measuring a grid power profile of a grid using one or more sensors;
comparing the measured grid power profile with a reference grid power profile;
determining a deviation between the measured grid power profile and the reference grid power profile;
determining a vehicle discharge power profile during discharging of a battery pack of a vehicle;
communicating a command to a control unit to modify the vehicle discharge power profile based on the deviation between the measured grid power profile and the reference grid power profile; and
receiving the modified vehicle discharge power profile from the control unit and transmitting the modified vehicle discharge power profile to the grid.

119. The non-transitory computer readable storage medium of claim 118, wherein the grid power profile comprises a voltage profile, a current profile, a frequency profile, and a power quality profile.

120. The non-transitory computer readable storage medium of claim 118, further comprising: selecting one or more vehicles for discharging based on the modified vehicle discharge power profile.

121. The non-transitory computer readable storage medium of claim 120, further comprising: grouping the one or more selected vehicles for discharging based on discharge capacity, state of charge (SoC), state of Health (SoH) of the battery pack, environmental conditions, and the grid power profile.

122. The non-transitory computer readable storage medium of claim 121, further comprising: controlling the discharging of the grouped vehicles when the deviation between the grid power profile and the reference grid power profile exceeds a predefined threshold.
